(19) United States
(12) Patent Application Publication
(10) Pub. No.: US 2015/0162014 A1
(43) Pub. Date: Jun. 11, 2015

(54) SYSTEMS AND METHODS FOR ENHANCING AN AUDIO SIGNAL

(71) Applicant: QUALCOMM Incorporated, San Diego, CA (US)

(72) Inventors: Shuhua Zhang, San Diego, CA (US); Juhan Nam, San Diego, CA (US); Erik Visser, San Diego, CA (US); Lae-Hoon Kim, San Diego, CA (US); Yinyi Guo, San Diego, CA (US)

(73) Assignee: QUALCOMM Incorporated, San Diego, CA (US)

(21) Appl. No.: 14/258,973

(22) Filed: Apr. 22, 2014

Related U.S. Application Data
(60) Provisional application No. 61/913,151, filed on Dec. 6, 2013.
(60) Provisional application No. 61/976,250, filed on Apr. 7, 2014.

(51) Int. Cl. G10L 19/02

(52) U.S. Cl. CPC G10L 19/02

(57) ABSTRACT

A method for enhancing an audio signal by an electronic device is described. The method includes determining formant peaks based on an audio signal. The method also includes generating formant peak models. Generating formant peak models includes individually modeling each formant peak. The method further includes generating a global envelope based on the formant peak models.

### RELATED APPLICATIONS

This application is related to and claims priority to U.S. Provisional Patent Application Ser. No. 61/913,151, filed Dec. 6, 2013, for “SYSTEMS AND METHODS FOR ENHANCING AN AUDIO SIGNAL,” and to U.S. Provisional Patent Application Ser. No. 61/976,250, filed Apr. 7, 2014, for “SYSTEMS AND METHODS FOR ENHANCING AN AUDIO SIGNAL.”

### TECHNICAL FIELD

The present disclosure relates generally to electronic devices. More specifically, the present disclosure relates to systems and methods for enhancing an audio signal.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., cellular phones, smartphones, audio recorders, camcorders, computers, etc.) capture and/or utilize audio signals. For example, a smartphone may capture a speech signal. The audio signals may be stored and/or transmitted.

In some cases, the audio signals may include a desired audio signal (e.g., a speech signal) and noise. High levels of noise in an audio signal can degrade the audio signal. This may render the desired audio signal unintelligible or difficult to interpret. As can be observed from this discussion, systems and methods that improve audio signal processing may be beneficial.

### SUMMARY

A method for enhancing an audio signal by an electronic device is described. The method includes determining formant peaks based on an audio signal. The method also includes generating formant peak models. Generating formant peak models includes individually modeling each formant peak. The method further includes generating a global envelope based on the formant peak models. Generating the global envelope based on the formant peak models may include one or more of performing a max operation on the formant peak models and concatenating the formant peak models.

Individually modeling each formant peak may include determining whether each formant peak is supported. Individually modeling each formant peak may also include selecting a modeling type for each formant peak based on whether each respective formant peak is supported. Individually modeling each formant peak may include, for each formant peak, modeling the formant peak based on a first modeling if the formant peak has at least one missing neighboring peak at a harmonic position of the formant peak or modeling the formant peak based on a second modeling if the formant peak has neighboring peaks at neighboring harmonic positions of the formant peak.

The method may include synthesizing phase based on the global envelope. Synthesizing the phase may be based on an inter-partial constraint and an inter-frame constraint.

The method may include performing harmonic analysis based on the audio signal. Performing harmonic analysis may include pruning a set of spectral peaks to obtain a pruned set of spectral peaks. Performing harmonic analysis may also include determining a fundamental frequency by determining a generalized common divisor of the pruned set of spectral peaks. Performing harmonic analysis may further include updating a voicing state based on the fundamental frequency. The method may include determining whether the audio signal includes one or more voiced frames based on the harmonic analysis. Determining formant peaks may only be performed for voiced frames.

The method may include generating a time-domain speech signal based on the global envelope. The method may include transmitting one or more of the formant peak models.

The method may include suppressing one or more isolated peaks based on the audio signal. Suppressing the one or more isolated peaks may include determining at least two peak isolation measures and updating an isolated peak state based on the at least two peak isolation measures.

An electronic device for enhancing an audio signal is also described. The electronic device includes formant peak determination circuitry configured to determine formant peaks based on an audio signal. The electronic device also includes global envelope generation circuitry coupled to the formant peak determination circuitry. The global envelope generation circuitry is configured to generate formant peak models and is configured to generate a global envelope based on the formant peak models. Generating formant peak models includes individually modeling each formant peak.

A computer-program product for enhancing an audio signal is also described. The computer-program product includes a non-transitory tangible computer-readable medium with instructions. The instructions include code for causing an electronic device to determine formant peaks based on an audio signal. The instructions also include code for causing the electronic device to generate formant peak models. Generating formant peak models includes individually modeling each formant peak. The instructions further include code for causing the electronic device to generate a global envelope based on the formant peak models.

An apparatus for enhancing an audio signal is also described. The apparatus includes means for determining formant peaks based on an audio signal. The apparatus also includes means for generating formant peak models. The means for generating formant peak models includes means for individually modeling each formant peak. The apparatus further includes means for generating a global envelope based on the formant peak models.

### BRIEF DESCRIPTION OF THE DRAWINGS

FIG. 1 illustrates one example of a speech spectrum;

FIG. 2 is illustrates another example of a speech spectrum;

FIG. 3 is a block diagram illustrating one example of an electronic device in which systems and methods for enhancing an audio signal may be implemented;

FIG. 4 is a flow diagram illustrating an example of a method for enhancing an audio signal;

FIG. 5 is illustrates another example of a speech spectrum;

FIG. 6 is a block diagram illustrating one example of an isolated peak suppressor;

FIG. 7 is a graph illustrating one example of an isolated peak;

FIG. 8 is a flow diagram illustrating one configuration of a method for isolated peak detection;

FIG. 9 includes a state diagram of one configuration of isolated peak detection;

FIG. 10 includes a graph that illustrates examples of peak detection;

FIG. 11 includes spectrogram plots that illustrate an example of isolated peak suppression;

FIG. 12 is a block diagram illustrating one configuration of a harmonic analysis module;

FIG. 13 includes graphs that illustrate an example of harmonic analysis in accordance with the systems and methods disclosed herein;

FIG. 14 includes a graph that illustrates an example of pitch candidates;

FIG. 15 includes a graph that illustrates an example of harmonic analysis in accordance with the systems and methods disclosed herein;

FIG. 16 is a block diagram illustrating another configuration of an electronic device in which systems and methods for enhancing an audio signal may be implemented;

FIG. 17 is a flow diagram illustrating one example of a method for enhancing an audio signal;

FIG. 18 is a flow diagram illustrating a more specific configuration of a method for enhancing an audio signal;

FIG. 19 includes a graph that illustrates one example of all-pole modeling in accordance with the systems and methods disclosed herein;

FIG. 20 includes a graph that illustrates one example of all-pole modeling with a max envelope in accordance with the systems and methods disclosed herein;

FIG. 21 includes graphs that illustrate one example of extended partials in accordance with the systems and methods disclosed herein;

FIG. 22 is a graph illustrating one example of a spectrum of a speech signal corrupted by noise;

FIG. 23 is a graph illustrating one example of a spectrum of a speech signal corrupted by noise after noise suppression;

FIG. 24 is a flow diagram illustrating an example of a method for envelope modeling;

FIG. 25 is a flow diagram illustrating one configuration of a method for picking harmonic peaks;

FIG. 26 is a graph illustrating one example of a spectrum of a speech signal with picked harmonic peaks;

FIG. 27 illustrates examples of peak modeling;

FIG. 28 is a graph illustrating an example of assignment of local envelopes for individual harmonic peaks;

FIG. 29 is a graph illustrating an example of assignment of a single local envelope for a group of harmonic peaks or a formant group;

FIG. 30 is a graph illustrating an example of a global envelope;

FIG. 31 is a graph illustrating an example of missing partial restoration;

FIG. 32 is a block diagram illustrating another configuration of an electronic device in which systems and methods for enhancing an audio signal may be implemented;

FIG. 33 is flow diagram illustrating one configuration of a method for synthesizing phase;

FIG. 34 is a flow diagram illustrating a more specific example of an approach for phase synthesis by inter-partial and inter-frame constraints;

FIG. 35 includes a graph illustrating an example of searching for a linear phase component as described in connection with FIG. 34;

FIG. 36 is a diagram illustrating an example of phase evolution as described in connection with FIG. 34;

FIG. 37 includes graphs illustrating another example of phase evolution as described in connection with FIG. 34; and

FIG. 38 illustrates various components that may be utilized in an electronic device.

### DETAILED DESCRIPTION

Some configurations of the systems and methods disclosed herein may relate to noise suppression and speech enhancement. Some problems with known filter-based noise suppression may include: (1) in-harmonic noise (write-in noise) that is due to insufficient noise level estimation, which may lead to lower signal-to-noise ratio improvement (SNRI); (2) residual peaks that are due to insufficient noise level estimation and/or unmatched microphone gain, which may be a complaint from subjective evaluation; (3) missing speech features that are due to overestimation of noise level, which may lead to nasal-sounding speech; and (4) weak low frequency content that is due to recording and/or noise over-subtraction, which may lead to band-limited speech.

Some configurations of the systems and methods disclosed herein may provide a framework to predict voiced speech amplitude and phase contours. This framework may allow analysis and synthesis of harmonic structure and temporal evolution of speech from noisy and highly incomplete speech signals. The framework may work for (1) reducing in-harmonic noise and non-harmonic residual peaks by removing energy between harmonics using fundamental frequency tracks; (2) suppressing isolated noise peaks at arbitrary positions identified by one or more (e.g., two) isolation measures; (3) restoring missing partials using harmonic component contours and (4) low bandwidth extension by the first harmonic component contour. Some configurations of the systems and methods disclosed herein may include one or more of the following techniques that lead to the working of the framework: (1) peak analysis and harmonic matching-based pitch detection and tracking; (2) isolated peak suppression at arbitrary positions; (3) dominant local all-pole modeling of speech envelope and (4) inter-partial and inter-frame constraints for missing harmonic components.

As described above, the systems and methods disclosed herein may provide a framework to predict voiced speech amplitude and phase contours. There are several motivations for the systems and methods disclosed herein. In particular, further improvement is needed for noisy speech enhanced by filter-based spatial and spectral processing over known approaches. For example, known approaches may suffer from underestimation of noise level and microphone gain mismatch. Known approaches may not resolve write-in noise, which may have a low-to-median perceptual impact, and residual peaks (e.g., chicken noise/musical noise/tonal noise), which may be a source of subjective evaluation complaints. Known approaches may also suffer from overestimation of a noise level. This may result in missing harmonic components (e.g., partials) and band-stopped speech. Accordingly, known approaches may not be able to effectively enrich speech. For example, known approaches may produce weak or missing fundamentals and/or band-limited speech.

Some current problems include lack of the ability to clean up and enrich speech at the same time, to distinguish speech and non-speech components and/or to know what speech components are missing and where they are missing.

One known approach involves manual tuning to trade noise suppression and speech preservation. However, this approach may be time-consuming and more like an art of multi-parameter optimization. This approach may result in weak or missing voiced speech features, without attempts to strengthen or recover them.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

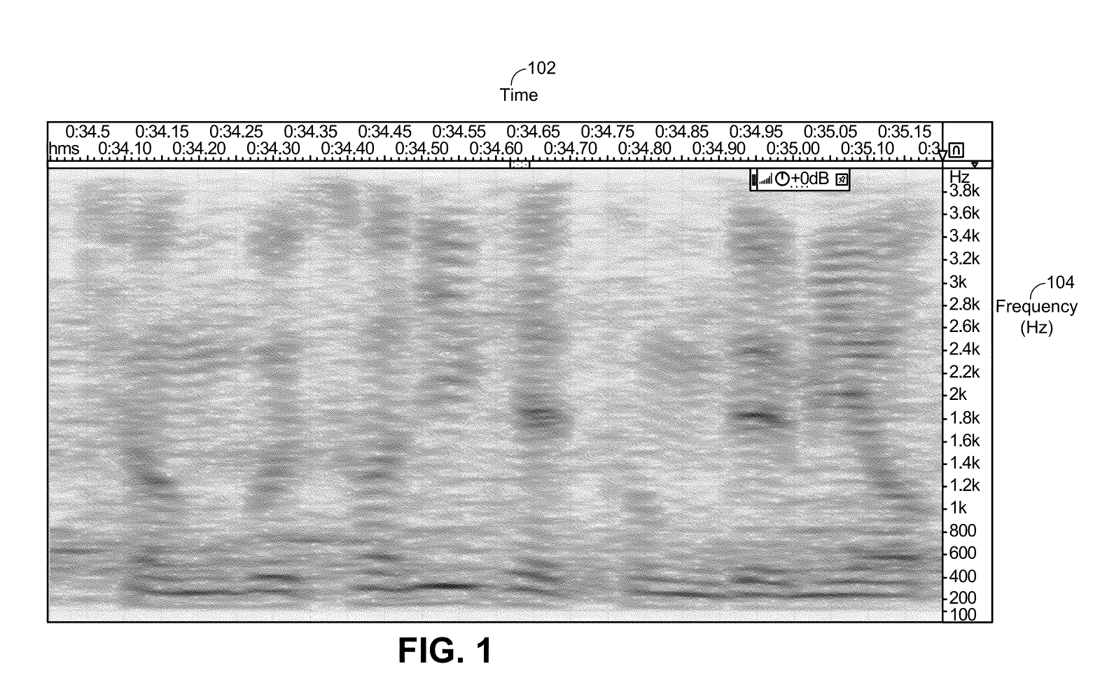

FIG. 1 illustrates one example of a speech spectrum. In particular, FIG. 1 includes a graph of a speech spectrum over time 102, where the horizontal axis is illustrated in time 102 (minute:second.milliseconds (ms)) and the vertical axis is illustrated in frequency 104 (hertz (Hz)). This speech spectral example illustrates a noisy audio signal for improvement. In particular, this speech spectrum is one example of an audio signal (e.g., noise suppression input) corrupted by pub noise.

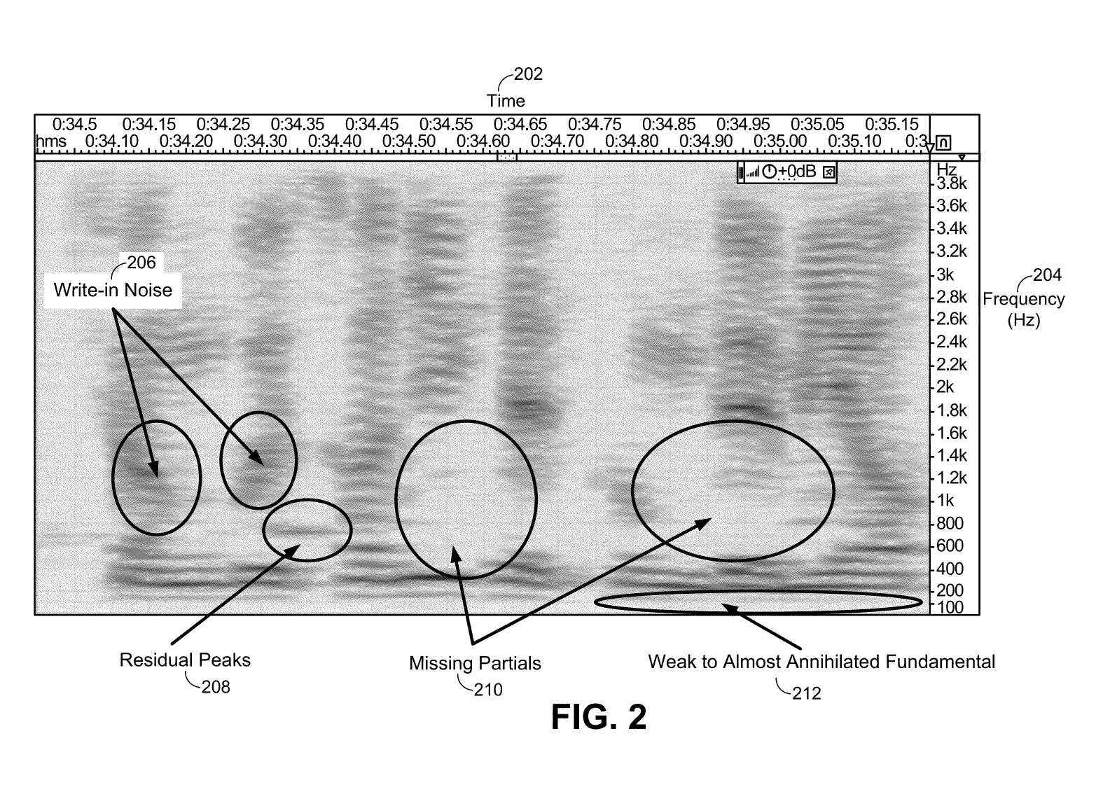

FIG. 2 illustrates another example of a speech spectrum. In particular, FIG. 2 includes a graph of a speech spectrum over time 202, where the horizontal axis is illustrated in time (minute:second.milliseconds) 202 and the vertical axis is illustrated in frequency (Hz) 204. The speech spectrum shown is one example of a noise-suppressed audio signal (at the output of a noise suppressor, for example) corresponding to the audio signal corrupted by pub noise described in connection with FIG. 1.

As illustrated in FIG. 2, this speech spectral example illustrates several areas of the spectrum for improvement. In particular, the spectrum illustrates write-in noise 206. Write-in noise 206 may occur in between harmonic partials and may not be adequately suppressed by noise suppression, as illustrated in FIG. 2. The spectrum also illustrates residual peaks 208. Residual peaks 208 may be noise peaks that remain after noise suppression. Write-in noise 206 and residual peaks 208 may be due to the underestimation of a noise level (in a noise suppressor, for example) and/or microphone gain mismatch.

Missing partials 210 are also illustrated. Missing partials 210 may be harmonic peaks that are missing from a speech spectrum. For example, speech often includes peaks at frequencies that are harmonics of a fundamental frequency. These peaks may be referred to as harmonic partials. As illustrated in FIG. 2, some harmonic partials may be missing from a speech spectrum. For instance, a noise suppressor may overestimate a noise level, leading to suppression of some harmonic partials. A weak fundamental frequency 212 (e.g., a weak-to-almost annihilated fundamental frequency 212) is also illustrated in FIG. 2. A weak fundamental frequency 212 may produce unnatural speech.

It may be beneficial to reduce or remove write-in noise 206 and/or residual peak(s) 208. Additionally or alternatively, it may be beneficial to enhance the speech spectrum by restoring missing partials 210 and/or by strengthening and/or restoring the weak fundamental 212. Achieving one or more of these objectives may improve the quality of a speech signal.

Some configurations of the systems and methods described herein may include performing speech modeling. Speech modeling may add a new dimension to known approaches. For example, a device may perform speech modeling based on a noisy and incomplete signal by capturing harmonic structure and its temporal evolution.

Some configurations of the systems and methods disclosed herein may be described in terms of mathematical symbols. For convenience, some of these symbols are defined as follows. A fundamental frequency trajectory may be denoted f₀(t). Time may be denoted t (e.g., in frame, seconds, sample number, etc.). Peak isolation measures may be denoted peak_Q₁ and peak_Q₂. A spectral envelope may be denoted |H(f)| and minimum phase may be denoted arg H(f). Group delay trajectory may be denoted d(t). Harmonic component contours may be expressed in relation to frequency (denoted fₖ(t)), amplitude (denoted Aₖ(t)) and/or phase (denoted φₖ(t)).

The systems and method disclosed herein may be utilized for improving speech and beyond. One or more of the following elements may be implemented in accordance with the systems and methods disclosed herein. One element may include reducing or removing anything (e.g., spectral energy) between harmonic components based on f₀(t). One benefit of this may be reduced write-in noise and/or reduced residual peaks at non-harmonic positions. Another element may include suppressing noises that exhibit isolation measures beyond a threshold amount (e.g., with isolation measures that are too high). One benefit of this may be reduced residual peaks at arbitrary positions. Another element may include reconstructing missing harmonic components based on fₖ(t), Aₖ(t), and/or φₖ(t). One benefit of this may be restored missing partials. Another element may include low bandwidth extension based on f₀(t), A₀(t), and/or φ₀(t), where A₀(t) is an amplitude and φ₀(t) is a phase at the fundamental frequency f₀(t). One benefit of this may be strengthened or reconstructed fundamentals. Another element may include reconstructing a signal (e.g., speech) from modified harmonic component contours. This may result in changed speed/pitch and/or voice. In some configurations, a prediction framework described herein may be based on a single channel. One benefit of this is reduced dependency on additional (e.g., second) microphone placement.

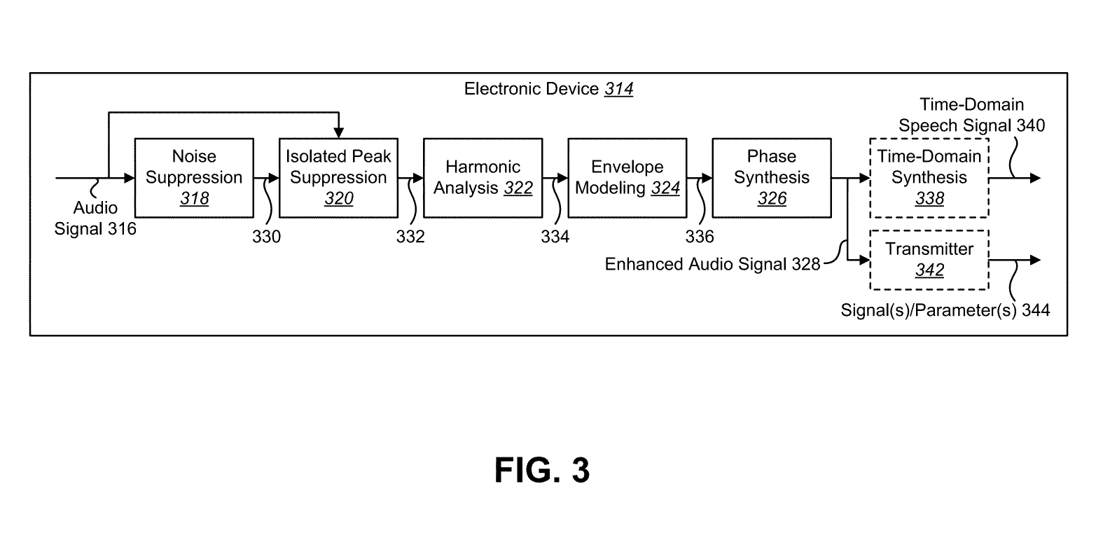

FIG. 3 is a block diagram illustrating one example of an electronic device 314 in which systems and methods for enhancing an audio signal 316 may be implemented. For instance, the electronic device 314 may be implemented in accordance with a framework to predict voiced speech amplitude and phase contours.

Examples of the electronic device 314 include cellular phones, smartphones, tablet devices, voice recorders, laptop computers, desktop computers, landline phones, camcorders, still cameras, in-dash electronics, game systems, televisions, appliances, etc. One or more of the components of the electronic device 314 may be implemented in hardware (e.g., circuitry) or a combination of hardware and software. As used herein, a “module” may be implemented in hardware (e.g., circuitry) or a combination of hardware and software.

Arrows and/or lines may denote couplings between components or elements in the block diagrams illustrated in the Figures. A “coupling” or variations of the term “couple” may denote a direct connection or indirect connection between components or elements. For example, a first component that is coupled to a second component may be connected directly to the second component (without intervening components) or may be indirectly connected to the second component (with one or more intervening components).

The electronic device 314 may include a noise suppression module 318, an isolated peak suppression module 320, a harmonic analysis module 322, an envelope modeling module 324 and/or a phase synthesis module 326. The electronic device 314 may obtain an audio signal 316. For example, the electronic device 314 may capture the audio signal 316 from one or more microphones included in the electronic device 314 (not shown in FIG. 3). In some configurations, the audio signal 316 may be a sampled version of an analog audio signal that has be converted by an analog-to-digital converter (ADC) (not shown in FIG. 3) included in the electronic device 314. In another example, the electronic device 314 may obtain the audio signal 316 from another device. For example, the electronic device 314 may receive the audio signal 316 from a Bluetooth headset or some other remote device (e.g., smartphone, camera, etc.). In some configurations, the audio signal 316 may be formatted (e.g., divided) into frames. The audio signal 316 (e.g., one or more frames of the audio signal 316) may be provided to the noise suppression module 318 and/or to the isolated peak suppression module 320. It should be noted that the noise suppression module 318 may be optional. For example, the systems and methods disclosed herein may work in conjunction with or independently from noise suppression.

It should be noted that one or more of the components of the electronic device 314 may be optional. For example, some implementations of the electronic device 314 may include only one of the components illustrated. Other implementations may include two or more of the components illustrated. In particular, some implementations of the electronic device 314 may include only one of the noise suppression module 318, the isolated peak suppression module 320, the harmonic analysis module 322, the envelope modeling module 324 and the phase synthesis module 326. Other implementations may include two or more of the components illustrated.

The noise suppression module 318 may suppress noise in the audio signal 316. For example, the noise suppression module 318 may detect and/or remove one or more interfering signals or components thereof from the audio signal 316. The noise suppression module 318 may produce a noise-suppressed audio signal 330. As described above in connection with FIG. 2, it may be beneficial to further remove noise and/or enhance the audio signal 316 after noise suppression.

The noise suppressed audio signal 330 and the (original) audio signal 316 may be provided to the isolated peak suppression module 320. The spectrum of the audio signal 316 (e.g., recorded speech at frame t) may be denoted X(f,t). The spectrum of the noise-suppressed audio signal 330 (e.g., noise-suppressed speech at frame t) may be denoted \hat{X}(f,t).

The isolated peak suppression module 320 may perform isolated peak suppression at arbitrary positions. An isolated peak is a tonal peak caused by noise in the audio signal 316. For example, tonal sounds caused by noise (e.g., music, interfering speakers, etc.) may remain in the noise-suppressed audio signal 330 after noise suppression. The isolated peak suppression module 320 may attempt to detect and reduce (e.g., remove) one or more isolated peaks from the audio signal 316 and/or the noise-suppressed audio signal 330.

In some configurations, the isolated peak suppression module 320 may use a difference between the noise suppression input (e.g., the original audio signal 316) and the noise suppression output (e.g., the noise-suppressed audio signal 330) to differentiate isolated peaks. The isolated peak suppression module 320 may use one or more (e.g., two) spectral isolation measures to distinguish isolated peaks from normal peaks.

The isolated peak suppression module 320 may use stationarity to track isolated peaks. The isolated peak suppression module 320 may suppress (e.g., reduce and/or remove) any detected isolated peaks to produce an isolated peak-suppressed audio signal 332. In some configurations, the spectrum of the isolated peak-suppressed audio signal 332 (e.g., spectrum of speech with isolated peaks removed at frame t) may be denoted \tilde{X}(f,t). The isolated peak-suppressed audio signal 332 may be provided to the harmonic analysis module 322.

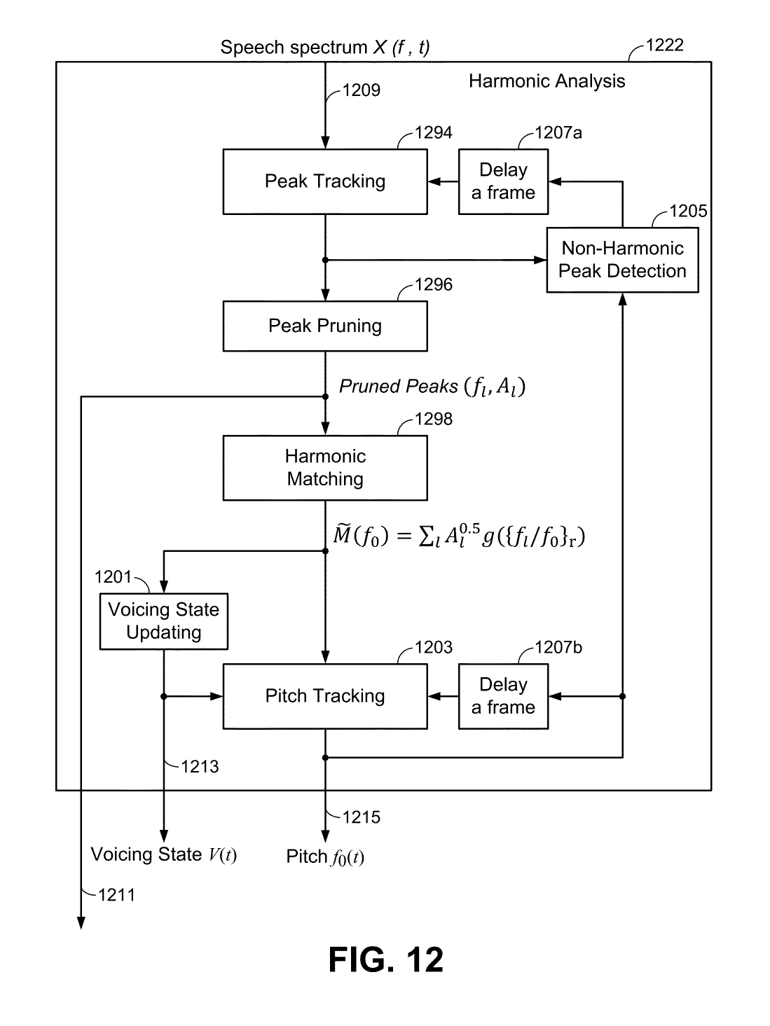

The harmonic analysis module 322 may perform harmonic analysis of a noisy and/or incomplete spectrum using peaks. In some configurations, the harmonic analysis module may determine one or more refined peak locations (denoted fₗ, for example), refined peak amplitudes (denoted Aₗ, for example) and/or one or more refined peak phases (denoted φₗ, for example). The refined peaks may be referred to as “pruned peaks” and/or “reliable peaks.” For example, the harmonic analysis module 322 may use more reliable information (e.g., the frequencies of reliable peaks) for noise robustness. For example, reliable peaks may be large enough (e.g., within an amplitude range from a strongest peak), have sufficient tonality, are far enough from a stronger peak and/or are not continuous from non-harmonic peaks of a previous frame. More detail is given in connection with FIG. 12.

The harmonic analysis module 322 may determine a fundamental frequency of the audio signal 316 (e.g., isolated peak-suppressed audio signal 316). For example, the fundamental frequency at frame t may be denoted f₀(t). In some configurations, the harmonic analysis module 322 may perform harmonic matching. The harmonic matching may be based on a generalized (greatest) common divisor approach that is robust to a large amount of missing partials. The harmonic analysis module 322 may perform dynamic pitch variance control (e.g., stable tracking without delay).

The harmonic analysis module 322 may provide spectral information 334 to the envelope modeling module 324. For example, the spectral information 334 may include the refined peak locations (e.g., fₗ), the refined peak amplitudes (e.g., Aₗ) and/or the fundamental frequency (e.g., f₀(t)).

In some configurations, the harmonic analysis module 322 may perform harmonic analysis in order to determine whether the audio signal 316 (e.g., each frame of the audio signal 316) includes voiced speech. Whether the audio signal 316 includes voiced speech may be indicated by a voicing state of each frame. The voicing states at frame t may be denoted V(t). In some configurations, the envelope modeling module 324 and/or the phase synthesis module 326 may only operate on voiced frames. For example, if the harmonic analysis module 322 determines that a frame includes voiced speech (as indicated by V(t), for instance), then the harmonic analysis module 322 may provide spectral information 334 to the envelope modeling module 324 for that voiced frame. However, if the harmonic analysis module 322 determines that a frame does not include voiced speech (as indicated by V(t), for instance), then the electronic device 314 may not perform envelope modeling and/or phase synthesis. For non-voiced frames, the electronic device 314 may utilize the isolated peak-suppressed audio signal 332 (e.g., \tilde{X}(f,t)) or the noise suppressed audio signal 330 (e.g., \hat{X}(f,t)) instead of generating an enhanced audio signal 328.

The envelope modeling module 324 may model an envelope of the audio signal 316. For example, the envelope modeling module 324 may determine formant peaks based on the audio signal 316. In some configurations, determining the formant peaks may be based on the spectral information 334 (e.g., refined peak locations (e.g., fₗ), refined peak amplitudes (e.g., Aₗ) and/or the fundamental frequency (e.g., f₀(t)). For example, the envelope modeling module 324 may determine the formant peaks as a number (e.g., 3-4) of the dominant peaks (e.g., local maxima) of the refined peaks. However, it should be noted that the envelope modeling module 324 may determine the formant peaks directly from the audio signal 316, the noise-suppressed audio signal 330 or the isolated peak-suppressed audio signal 332 in other configurations. As described above, the envelope modeling module 324 may model an envelope only for frames of the audio signal 316 that include voiced speech in some configurations.

The envelope modeling module 324 may generate formant peak models. Each of the formant peak models may be formant peak envelopes (over a spectrum, for example) that model a formant peak. Generating the formant peak models may include individually modeling each formant peak. For example, the envelope modeling module 324 may utilize one or more model types to individually model each formant peak. This may be different from some known approaches that model an entire spectrum with a single model. Some examples of model types that may be utilized to generate the formant peak models include filters, all-pole models (where all-poles models resonate at the formant peak), all-zero models, autoregressive-moving-average (ARMA) models, etc. It should be noted that different order models may be utilized. For example, all-pole models may be second-order all-pole models, third-order all-pole models, etc.

In some configurations, the envelope modeling module 324 may perform dominant local all-pole modeling of an envelope from incomplete spectrum. For example, the envelope modeling module 324 may use formant peaks (e.g., only formant peaks) for local all-pole modeling.

The envelope modeling module 324 may generate a global envelope (e.g., H(f)) based on the formant peak models. For example, the envelope modeling module 324 may determine formant peak envelopes and merge the formant peak envelopes to produce the global envelope of the frame (e.g., voiced frame). This may produce an envelope from highly incomplete spectral information. In some configurations, the envelope modeling module 324 may merge separate envelopes from the local all-pole modeling based on a maximum (e.g., “max”) operation or a L^{p}-norm operation. For example, the maximum amplitude of all the formant peak models (e.g., envelopes) over the spectrum may yield a max envelope. This may maintain local consistency at formant peaks and nearby. In some configurations, discrete-all-pole (DAP) modeling may be performed on the max envelope to yield the global envelope. In other configurations, the max envelope may be smoothed with a smoothing filter or a smoothing algorithm to yield the global envelope. In yet other configurations, the max envelope itself may be utilized as the global envelope.

In some configurations, the envelope modeling module 324 may perform missing partial prediction. For example, the envelope modeling module 324 may determine missing partials at harmonic frequencies of the fundamental frequency (e.g., at fₖ=kf₀, where k is a set of integers). The envelope modeling module 324 may determine the missing partial amplitudes as the magnitudes (e.g., absolute values) of the global envelope at each of the harmonic frequencies (e.g., Aₖ=|H(fₖ)|). The envelope modeling module 324 may also determine the missing partial minimum phases (e.g., φₖ^{m}=arg H(fₖ)).

The envelope modeling module 324 may provide envelope information 336 to the phase synthesis module 326. In some configurations, the envelope information 336 may include the global envelope (e.g., H(f)). Additionally or alternatively, the envelope information 336 may include extended peak information (e.g., harmonic frequencies fₖ, missing partial amplitudes Aₖ and/or missing partial minimum phases φₖ^{m}). For instance, the envelope information 336 may include H(f), fₖ, Aₖ and/or φₖ^{m}.

The phase synthesis module 326 may synthesize phase. For example, the phase synthesis module 326 may perform phase resynthesis based on an inter-partial constraint and an inter-frame constraint. This may maintain fine and consistent temporal structures for the missing partials. The phase synthesis module 326 may use only reliable peaks to derive minimum phase compensated group delay, which is then used to relate phases across partials. The phase synthesis module 326 may constrain frame-to-frame phase variation of the same partial to a range centered at the phase for maximal consistency across frames.

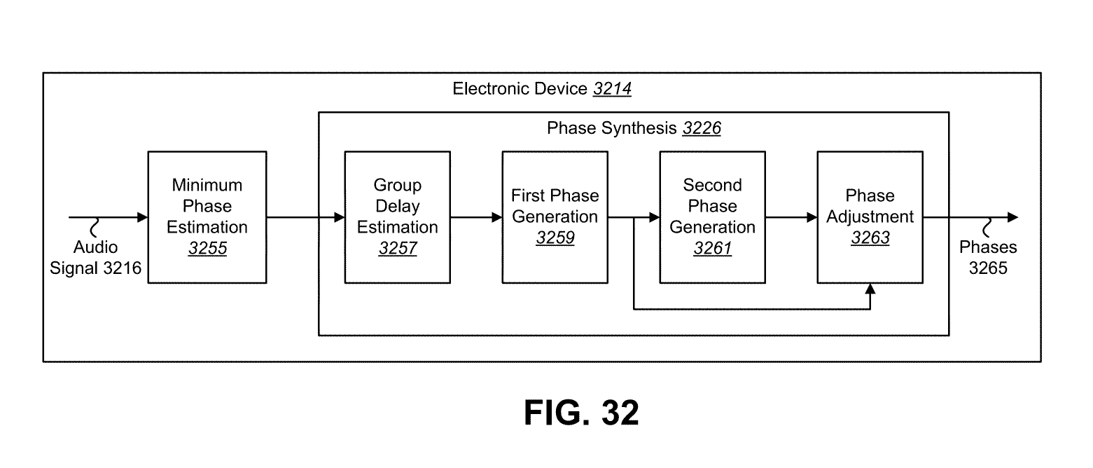

In some configurations, the phase synthesis module 326 may perform one or more of the following operations. The phase synthesis module 326 may estimate phases φₗ of refined peaks and/or a plurality of minimum phases for a current frame. The phase synthesis module 326 may estimate a group delay for the current frame based on the phases φₗ of the refined peaks. The phase synthesis module 326 may also generate a plurality of first phases based on the group delay and the plurality of minimum phases. The phase synthesis module 326 may further generate a plurality of second phases based on a comparison between a first portion of the current frame and a second portion of a previous frame. The phase synthesis module 326 may additionally adjust the plurality of first phases based on the plurality of second phases. More detail is provided in connection with FIGS. 32-37.

In some configurations, the phase synthesis module 326 may perform missing partial phase prediction. For example, the phase φₖ of the extended peak at fₖ is set to the adjusted first phase at fₖ, as described above. It should be noted that for the refined peaks (in contrast to the extended peaks), the phase synthesis module 326 may utilize the adjusted first phases, as described above, or utilize directly refined peak phases φₗ based on the spectral information 334 in some configurations.

The phase synthesis module 326 may provide an enhanced audio signal 328. For example, the spectrum of speech with noise removed and missing partials restored for voiced frame t may be denoted X̅(f,t). The spectrum X̅(f,t) may be derived from the refined peak information (fₗ, Aₗ, φₗ) and extended peak information (fₖ, Aₖ, φₖ), for example, by placing a zero-phase unit-amplitude peak template (e.g., the main lobe of the frequency response of the window function used in a time-to-frequency transform) at each of the locations fₗ and fₖ, scaling the template to the corresponding amplitude Aₗ, or Aₖ, and then shifting the phase of the template to the corresponding phase φₗ, or φₖ. As described above, the enhanced audio signal 328 may only be produced for voiced frames in some configurations. For non-voiced frames, the electronic device 314 may utilize the isolated peak-suppressed audio signal 332 (e.g., \tilde{X}(f,t)) or the noise suppressed audio signal 330 (e.g., \hat{X}(f,t)) instead of generating the enhanced audio signal 328.

In some configurations, the enhanced audio signal 328 may be optionally provided to an optional time-domain synthesis module 338. The time-domain synthesis module 338 may generate a time-domain speech signal 340 based on the enhanced audio signal 328. The time-domain speech signal may be obtained, for example, by applying a frequency-to-time transform for each frame, and then applying a weighted overlap-and-add operation to the transformed signal for each frame.

In some configurations, the enhanced audio signal 328 (and/or one or more signals and/or parameters utilized to derive the enhanced audio signal 328 may be optionally provided to an optional transmitter 342. The transmitter 342 may transmit the enhanced audio signal 328 and/or one or more signals and/or parameters utilized to derive the enhanced audio signal 328. For example, one or more of the aforementioned signals and/or parameters 344 (e.g., one or more of the formant peak models, V(t), f₀(t), fₗ, Aₗ, φₗ, \hat{X}(f,t), \tilde{X}(f,t), H(f), fₖ, Aₖ, φₖ, X̅(f,t)) may be transmitted to a remote device. It should be noted that one or more of the minimum phases φₗ^{m} and φₖ^{m} may be internal parameters that may be utilized to derive the overall phase of peaks. In some configurations, one or more of the aforementioned signals and/or parameters 344 may be quantized before transmission.

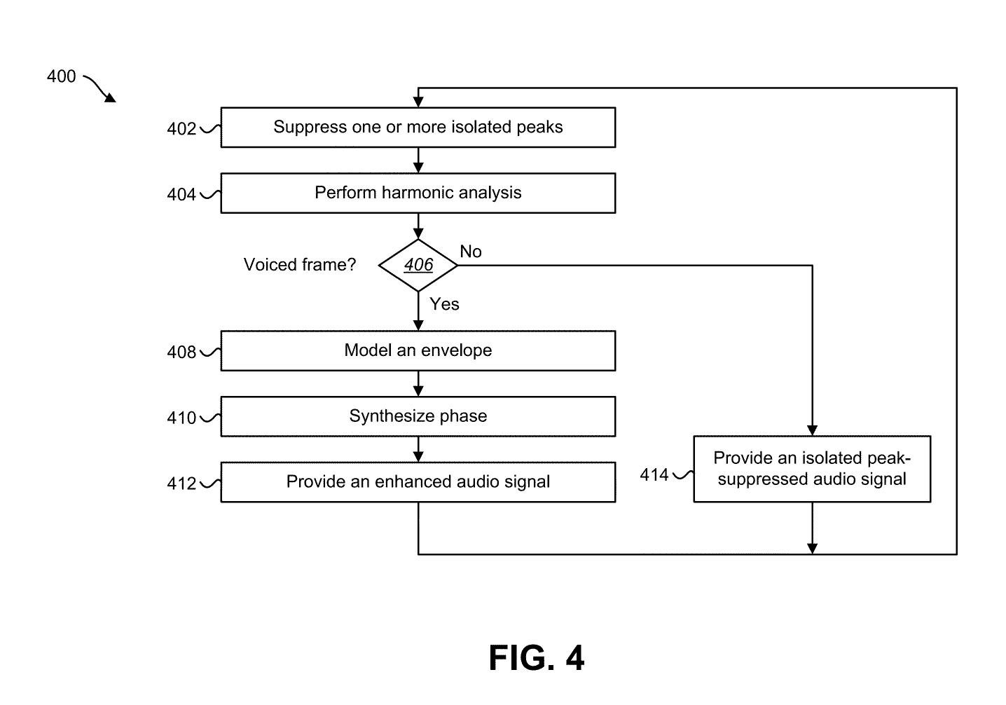

FIG. 4 is a flow diagram illustrating an example of a method 400 for enhancing an audio signal 316. In particular, FIG. 4 provides one example of performing analysis and synthesis of harmonic structure and temporal evolution of an audio signal 316. An electronic device 314 may suppress 402 one or more isolated peaks (e.g., may perform isolated peak suppression). This may be accomplished as described above in connection with FIG. 3. In some configurations, the electronic device 314 may determine one or more peak isolation measures and update an isolated peak state based on the peak isolation measures. Suppressing 402 one or more isolated peaks may produce an isolated peak-suppressed audio signal 332.

The electronic device 314 may perform 404 harmonic analysis based on spectral peaks. This may be accomplished as described above in connection with FIG. 3. For example, the electronic device 314 may perform 404 harmonic analysis in order to determine whether the frame includes voiced speech and/or to determine a fundamental frequency. In some configurations, this may include pitch detection and tracking based on peak analysis and harmonic matching.

If the frame does not include voiced speech, then the electronic device 314 may provide 414 the isolated peak-suppressed audio signal 332. For example, the electronic device 314 may utilize the spectrum of the isolated peak-suppressed audio signal 332 (e.g., spectrum of speech with isolated peaks removed at frame t, \tilde{X}(f,t)). In some configurations, the electronic device 314 may generate a time-domain speech signal based on the isolated peak-suppressed audio signal. The time-domain speech signal may be stored and/or output (e.g., played over a speaker, headphones, etc.). Additionally or alternatively, the electronic device 314 may transmit the isolated peak-suppressed audio signal 332 and/or one or more parameters representing the isolated peak-suppressed audio signal 332 to a remote device. In some configurations, the electronic device 314 may then return to suppressing 402 one or more isolated peaks for a next frame.

If the frame includes voiced speech, the electronic device 314 may model 408 an envelope. This may be accomplished as described above in connection with FIG. 3. For example, the electronic device 314 may determine formant peaks, generate formant peak models and/or generate a global envelope for the voiced frame.

The electronic device 314 may synthesize 410 phase. This may be accomplished as described above in connection with FIG. 3. For example, synthesizing 410 phase may include estimating minimum phases, estimating group delay, generating two pluralities of phases and adjusting one of the pluralities of phases based on the other.

The electronic device 314 may provide 412 an enhanced audio signal 328. This may be accomplished as described above in connection with FIG. 3. For example, the electronic device 314 may generate a time-domain speech signal 340 based on the enhanced audio signal 328. Additionally or alternatively, the electronic device 314 may transmit the enhanced audio signal 328 and/or one or more signals and/or parameters utilized to derive the enhanced audio signal 328.

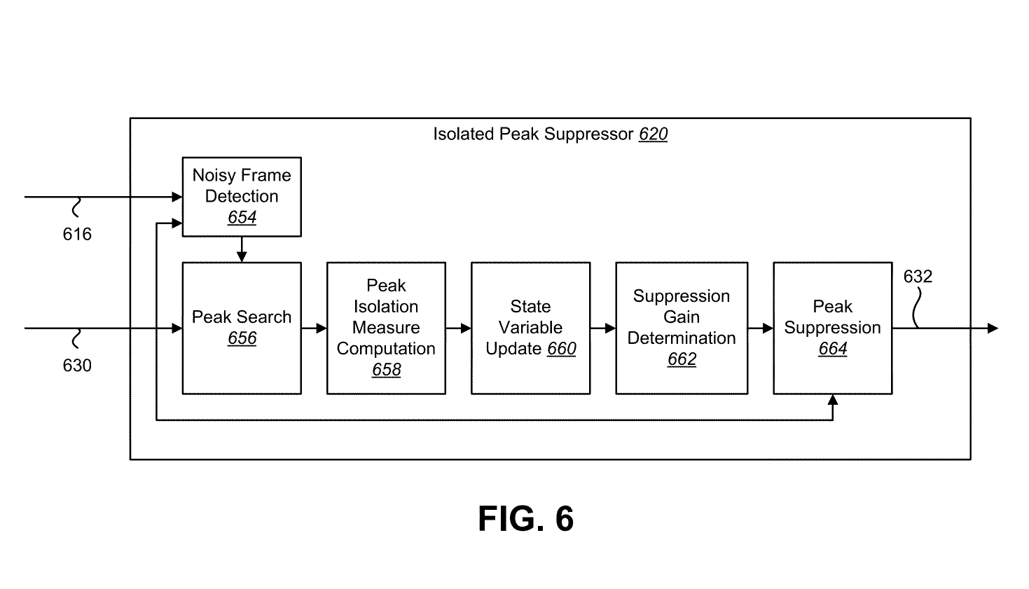

In some configurations, the electronic device 314 may enhance an impaired speech spectrum to generate a restored speech spectrum (e.g., enhanced audio signal 328). In some configurations, the electronic device 314 may perform peak refinement (to provide refined peak locations fₗ(t), refined peak amplitudes Aₗ(t) and/or refined peak phases φₗ(t), for example), envelope modeling (to provide the mth formant pole frequency ωₘ and pole strength pₘ using a 2-pole model, for example) and/or peak enrichment (to provide harmonic frequencies fₖ(t), missing partial amplitudes Aₖ(t) and/or phases φₖ(t), for example). The pole frequency ωₘ may be set to formant peak frequency, or interpolated from peak frequencies around the formant peak, for example. The pole strength pₘ may be set to a pre-defined number between 0 and 1 (e.g., 0.9) or estimated from peak amplitudes around the formant peak. It should be noted that the method 400 may additionally or alternatively perform one or more functions and/or procedures in accordance with additional detail provided in connection with one or more of FIGS. 6-37.

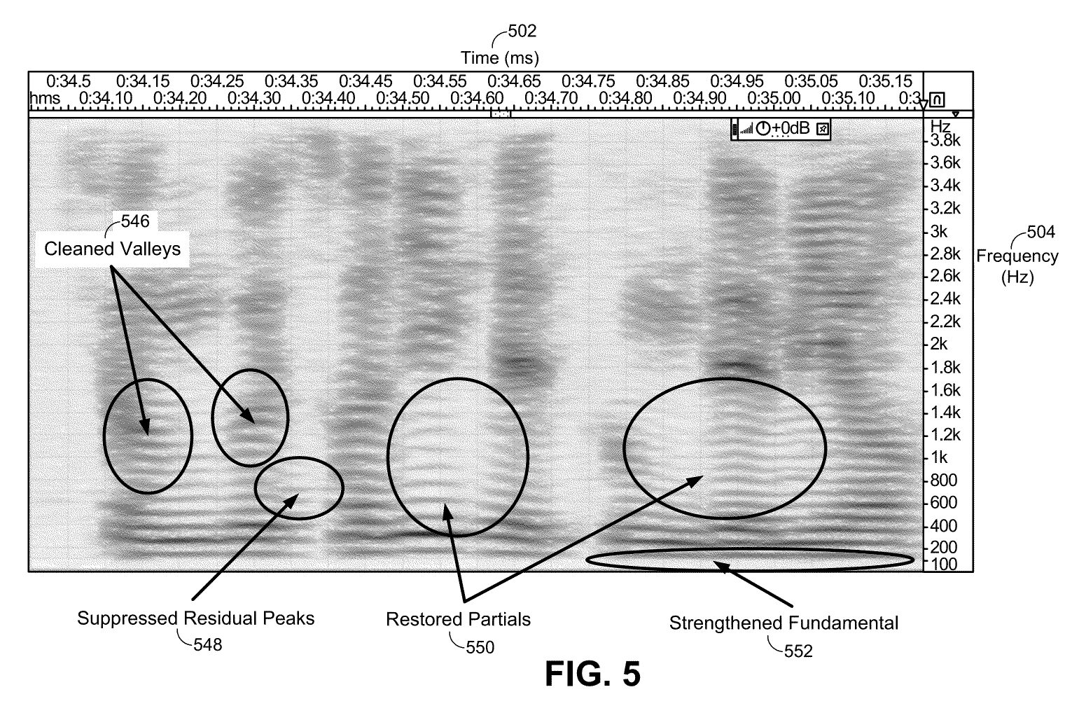

FIG. 5 is illustrates another example of a speech spectrum. In particular, FIG. 5 includes a graph of a speech spectrum over time 502, where the horizontal axis is illustrated in time (ms) 502 and the vertical axis is illustrated in frequency (Hz) 504. This speech spectral example illustrates improvement over the noise-suppressed audio signal (at the output of a noise suppressor, for example) described in connection with FIG. 2. In particular, FIG. 5 illustrates one example of the enhanced audio signal 328 (e.g., speech modeling output) after noise suppression and speech modeling of an audio signal corrupted with pub noise in accordance with the systems and methods disclosed herein. Specifically, the example illustrated in FIG. 5 shows cleaned valleys 546 (which addresses write-in noise), suppressed residual peaks 548, restored partials 550 and a strengthened fundamental 552 in comparison with the speech spectrum described in connection with FIG. 2.

FIG. 6 is a block diagram illustrating one example of an isolated peak suppressor 620. The isolated peak suppressor 620 described in connection with FIG. 6 may be one example of the isolated peak suppression module 320 described in connection with FIG. 3 and/or may provide an example of suppressing 402 one or more isolated peaks as described in connection with FIG. 4. In particular, FIG. 6 provides observations and solutions for suppressing isolated peaks.

The isolated peak suppressor 620 may perform isolated peak suppression. For example, filtering-based noise suppression systems often create isolated tonal peaks. These isolated tonal peaks may sound unnatural and annoying. The isolated tonal peaks may be caused by noise under-estimation for non-stationary noises, microphone gain mismatch, acoustic room conditions and so on. The isolated peak suppressor 620 may include a noisy frame detection module 654, a peak search module 656, a peak isolation measure computation module 658, a state variable update module 660, a suppression gain determination module 662 and/or a peak suppression module 664.

The noisy frame detection module 654 may detect noisy frames based on the audio signal 616 (e.g., noise suppression input) and the noise-suppressed audio signal 630 (e.g., noise suppression output). In particular, it may be observed that isolated tonal peaks are usually generated in frames where noise is dominant. Thus, the ratio between the noise-suppressed audio signal 630 (e.g., the noise suppression output) energy and the audio signal 616 (e.g., input) energy may be utilized to differentiate frames containing isolated peaks from speech frames. For example, the noisy frame detection module 654 may compute the energy ratio between the noise-suppressed audio signal 630 and the audio signal 616. The energy ratio may be compared to a threshold. Frames with an energy ratio below the threshold value may be designated as noisy frames in some configurations.

The peak search module 656 may search for peaks (optionally in frames that are detected as noisy). For example, the peak search module 656 may search for local maxima in the spectrum of the noise-suppressed audio signal 630.

The peak isolation measure computation module 658 may determine one or more peak isolation measures based on any peak(s) detected by the peak search module 656. Neighboring bins of isolated peaks usually have very low energy. Accordingly, comparing peak energy and neighboring bin energy may be used to detect the isolated peaks. For example, the peak isolation measure computation module 658 may compute one or more metrics that measure peak isolation. In some configurations, the peak isolation measure computation module 658 may compute a first peak isolation measure (e.g., peak_Q₁) and a second peak isolation measure (e.g., peak_Q₂).

For instance, two peak isolation measures may be defined for isolated peak suppression. A first peak isolation measure may be defined as

$${peak\_Q}_{1} = \frac{peak\_energy ( t , f )}{max ( neighboring\_bin \_energy ( t , f ) )} .$$

In some configurations, peak_energy (for a frame t and a frequency bin f, for example) may be determined based on a sum of squares of samples over a peak range (e.g., a range of samples over which the peak is defined). This peak_energy may be divided by a maximum of neighboring_bin_energy of the frame (e.g., the current frame, frame t). The first peak isolation measure peak_Q₁ may be computed within a frame. Conceptually, this may be considered similar to a “Q factor” in filter design. While natural speech signals maintain a low value when the range of neighboring bins is wide enough, isolated peaks may have a high value. In some configurations, suppression gain may be determined as inversely proportional to peak_Q₁.

A second peak isolation measure may be defined as

$${peak\_Q}_{2} = \frac{peak\_energy ( t , f )}{max ( peak\_energy ( t - 1 , f ) )} .$$

The second peak isolation measure peak_Q₂ may be computed between the previous frame (t−1) and the current frame (t). This may be used to detect the onset of isolated peaks.

In some cases, the isolated peaks are sustained for one or more frames after they are created (or “born”). The peaks may be tracked via state update. The state variable update module 660 may update an isolated peak state based on the peak isolation measures. For example, the state variable update module 660 may determine a state based on the peak isolation measure(s). In some configurations, the state variable update module 660 may determine whether an isolated peak state is idle, onset or sustained. The onset state may indicate that the beginning of an isolated peak has been detected. The sustained state may indicate that an isolated peak is continuing. The idle state may indicate that no isolated peak is detected.

The suppression gain determination module 662 may determine a suppression gain for suppressing isolated peaks. For example, the suppression gain may be a degree of suppression utilized to suppress an isolated peak. In some configurations, the suppression gain determination module 662 may determine the suppression gain as inversely proportional to a peak isolation measure (e.g., to the first peak isolation measure or peak_Q₁). The suppression gain determination module 662 may operate when the state variable update module 660 indicates onset or sustained, for example.

The peak suppression module 664 may suppress (e.g., attenuate, reduce, subtract, remove, etc.) isolated peaks in the noise-suppressed audio signal 630 (e.g., noise suppression output). For example, the peak suppression module 664 may apply the suppression gain determined by the suppression gain determination module 662. The output of the isolated peak suppressor 620 may be an isolated peak-suppressed audio signal (e.g., an audio signal with one or more suppressed isolated peaks). Additional detail is provided as follows.

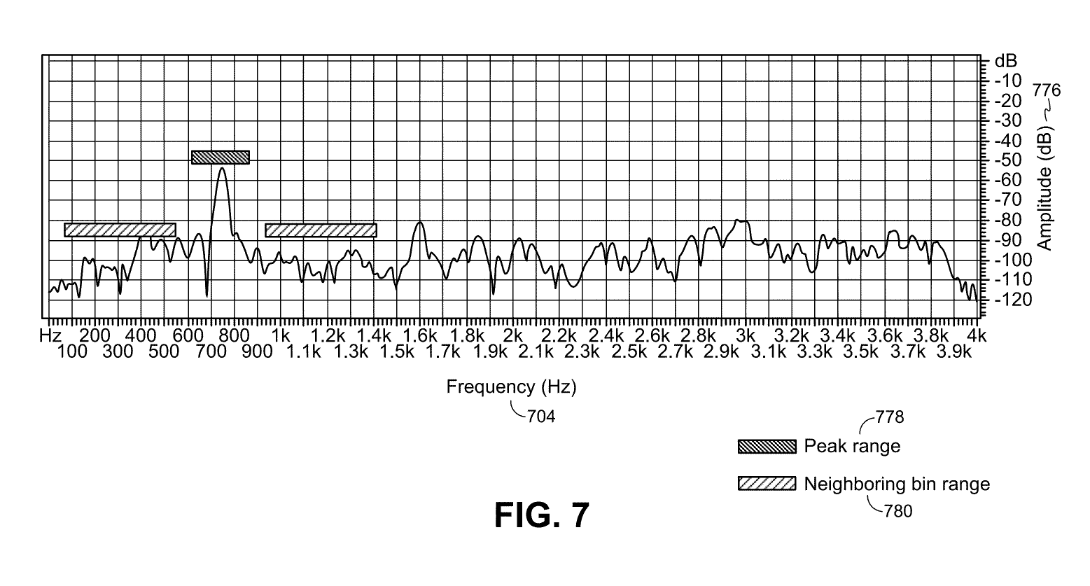

FIG. 7 is a graph illustrating one example of an isolated peak. In particular, FIG. 7 includes a graph of a signal spectrum, where the horizontal axis is illustrated in frequency (Hz) 704 and the vertical axis is illustrated in amplitude in decibels (dB) 776. Specifically, FIG. 7 illustrates an isolated peak range 778 and a neighboring bin range 780, which may be utilized to determine (e.g., compute) one or more of the isolation peak measures described in connection with FIG. 6. For example, the peak measure isolation measure computation module 658 may determine the peak isolation measure(s) based on the peak range 778 and the neighboring bin range 780.

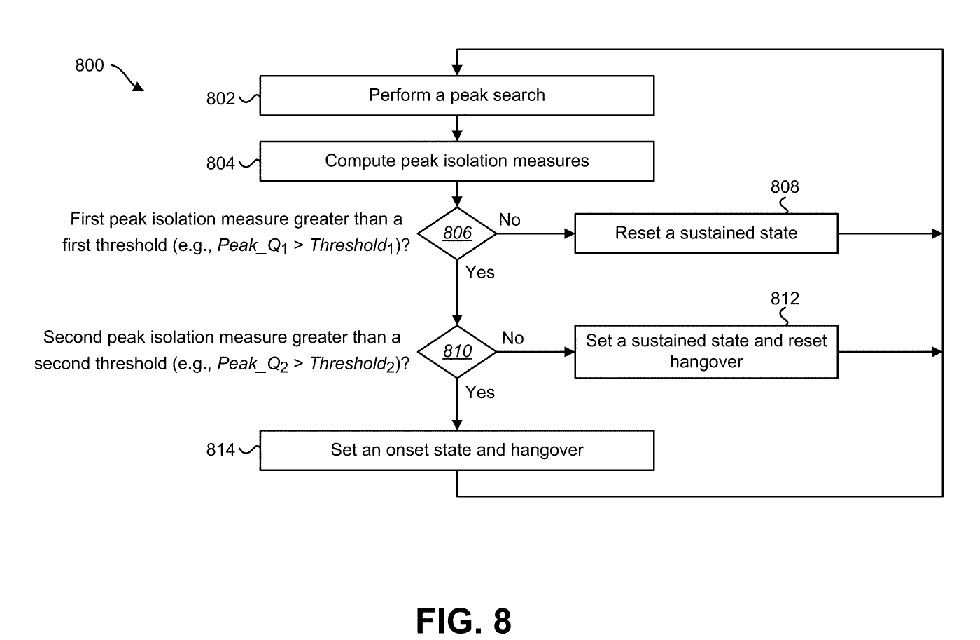

FIG. 8 is a flow diagram illustrating one configuration of a method 800 for isolated peak detection. The method 800 may be performed by the isolated peak suppression module 320 described in connection with FIG. 3 and/or by the isolated peak suppressor 620 described in connection with FIG. 6. Isolated peak detection may be based on isolated peak state updates, which may be utilized for isolated peak suppression. In the configuration illustrated in FIG. 8, each frequency bin has a corresponding state variable with three states: “idle,” “onset” and “sustained.” The states are updated based on a first peak isolation measure (e.g., peak_Q₁) and a second peak isolation measure (e.g., peak_Q₂).

The isolated peak suppressor 620 may perform 802 a peak search. This may be accomplished as described above in connection with FIG. 6. For example, the isolated peak suppressor 620 may search for local maxima in the spectrum of a noise-suppressed audio signal 630. In some configurations, the peak search may be performed for noisy frames.

The isolated peak suppressor 620 may compute 804 peak isolation measures. This may be accomplished as described above in connection with FIG. 6. For example, the isolated peak suppressor 620 may compute a first peak isolation measure (e.g., peak_Q₁) and a second peak isolation measure (e.g., peak_Q₂).

The peak isolation measures may be compared to corresponding thresholds (e.g., threshold₁ and threshold₂) in order to update the state. In some configurations, variables (e.g., Q₁, Q₂ and hangover) may be utilized to determine the state. For example, Q₁=1 if peak_Q₁>threshold₁. Otherwise, Q₁=0. Additionally, Q₂=1 if peak_Q₂>threshold₂. Otherwise, Q₂=0. It should be noted that suppression gain may be “1” if the state is idle in some configurations. Furthermore, suppression gain may be less than “1” if the state is onset or sustained. As described above, the suppression gain may be determined to be inversely proportional to peak_Q₁.

The isolated peak suppressor 620 may determine 806 whether the first peak isolation measure is greater than a first threshold (e.g., peak_Q₁>threshold₁). For example, the isolated peak suppressor 620 may determine Q₁. If the first peak isolation measure is not greater than the first threshold (e.g., peak_Q₁ threshold₁ and therefore Q₁=0), then the isolated peak suppressor 620 may reset 808 the sustained state. If the first peak isolation measure is greater than the first threshold (e.g., peak_Q₁>threshold₁ and therefore Q₁=1), then the isolated peak suppressor 620 may determine 810 whether the second peak isolation measure (e.g., peak_Q₂) is greater than the second threshold (e.g., peak_Q₂>threshold₂). For example, the isolated peak suppressor 620 may determine Q₂.

If the second peak isolation measure is not greater than the second threshold (e.g., peak_Q₂ threshold₂ and therefore Q₂=0), then the isolated peak suppressor 620 may set 812 the sustained state and reset hangover (e.g., a hangover variable may be set to 0). For example, the isolated peak suppressor 620 may track the detected peak for a certain period of time. If the second peak isolation measure is greater than the second threshold (e.g., peak_Q₂>threshold₂ and therefore Q₂=1), then the isolated peak suppressor 620 may set 814 the onset state and hangover (e.g., the hangover variable may be set to 1). For example, the isolated peak suppressor 620 may detect the “birth” of a new isolated peak.

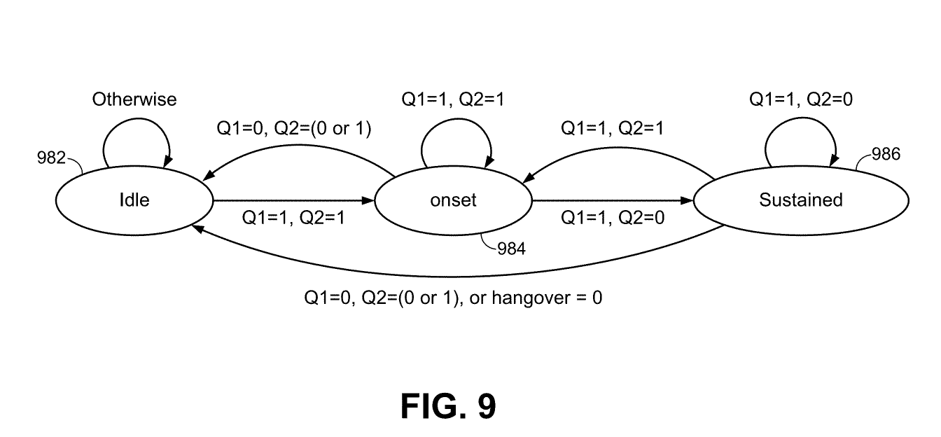

FIG. 9 includes a state diagram (e.g., state-machine view) of one configuration of isolated peak detection. For example, the isolated peak suppression module 320 described in connection with FIG. 3 and/or by the isolated peak suppressor 620 (e.g., the state variable update module 660) described in connection with FIG. 6 may operate in accordance with the method 800 described in connection with FIG. 8 and/or in accordance with the states described in connection with FIG. 9. As illustrated in FIG. 9, peak detection and/or tracking may operate in accordance with an idle state 982, an onset state 984 and a sustained state 986. In this configuration, transitions between states may occur based on variables Q₁ and Q₂ as described above in connection with FIG. 8. As described above, Q₁=1 if peak_Q₁>threshold₁ (with Q₁=0 otherwise) and Q₂=1 if peak_Q₂>threshold₂ (with Q₂=0 otherwise). Although described in terms of Q₁ and Q₂ for convenience, it should be noted that the transitions described in FIG. 9 can be equivalently described in terms of whether the first peak isolation measure is greater than a first threshold and whether the second peak isolation measure is greater than a second threshold.

The idle state 982 may transition to the onset state 984 if Q₁=1 and Q₂=1 (e.g., if peak_Q₁>threshold₁ and peak_Q₂>threshold₂). Otherwise, isolated peak detection stays in the idle state 982.

The onset state 984 may transition to the idle state 982 if Q₁=0 (whether Q₂ is 0 or 1, for example). Isolated peak detection may stay in the onset state 984 if Q₁=1 and Q₂=1. The onset state 984 may transition to the sustained state 986 if Q₁=1 and Q₂=0. Isolated peak detection may stay in the sustained state 986 if Q₁=1 and Q₂=0. The sustained state 986 may transition to the onset state 984 if Q₁=1 and Q₂=1. The sustained state 986 may transition to the idle state 982 if Q₁=0 (whether Q₂ is 0 or 1, for example) or if hangover=0.

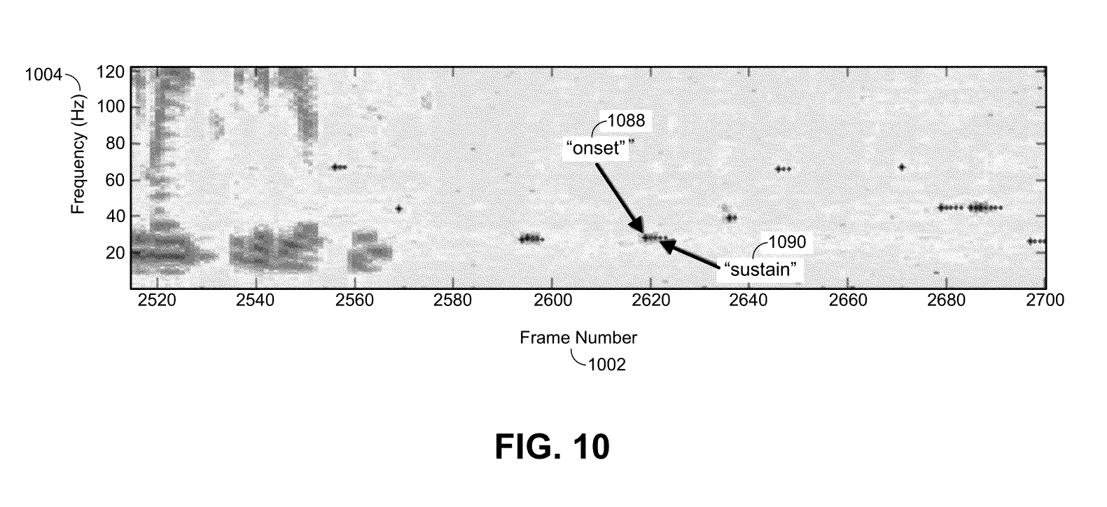

FIG. 10 includes a graph that illustrates examples of peak detection. In particular, FIG. 10 includes a graph of a speech spectrum over frame number 1002, where the horizontal axis is illustrated in frame number 1002 and the vertical axis is illustrated in frequency (Hz) 1004. In particular, the dots on the graph illustrate detected peaks, where a first dot denotes onset 1088 (e.g., the onset state as described in connection with FIGS. 8 and/or 9) of an isolated peak and subsequent dots denote isolated peak sustain 1090 (e.g., the sustained state as described in connection with FIGS. 8 and/or 9).

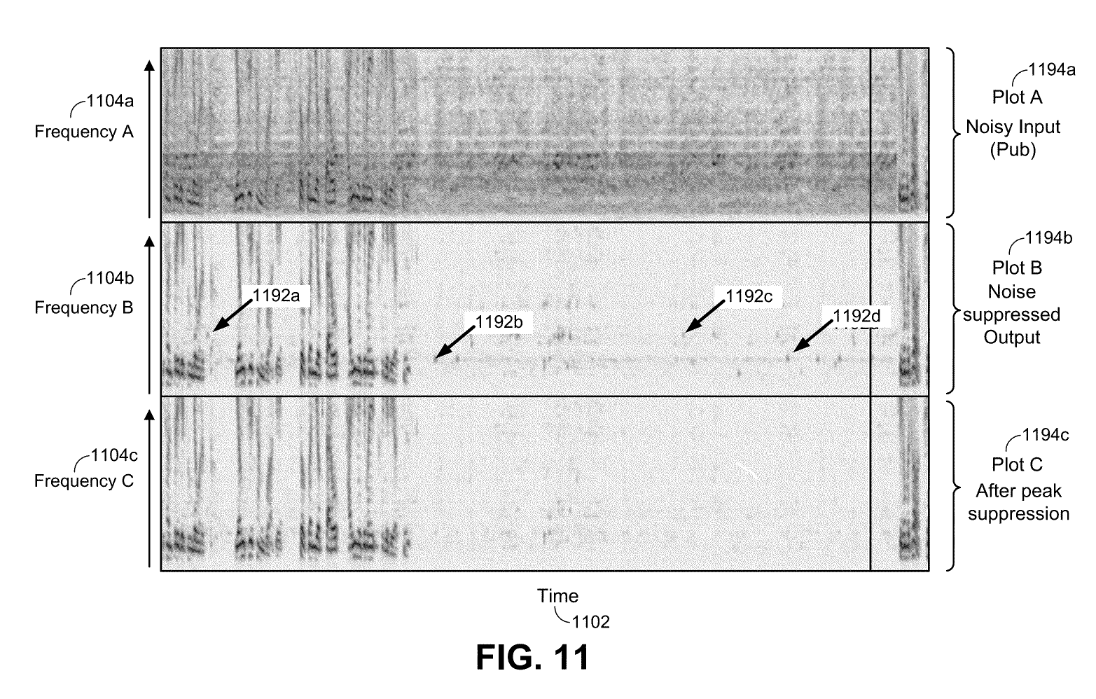

FIG. 11 includes spectrogram plots that illustrate an example of isolated peak suppression. In particular, plot A 1194a is an example of a noisy audio signal (with public noise) and is illustrated in frequency A 1104a over time 1102. Plot B 1194b is an example of a noise suppressed audio signal and is illustrated in frequency B 1104b over time 1102. Plot C 1194c is an example of an audio signal after isolated peak detection and suppression in accordance with the systems and methods disclosed herein. Plot C 1194c is illustrated in frequency C 1104c over time 1102.

In plot B 1194b, several isolated peaks 1192a-d remaining after noise suppression are illustrated. After isolated peak detection and suppression, the isolated peaks have been reduced or removed as illustrated in plot C 1194c. As illustrated, the systems and methods disclosed herein may suppress isolated peaks effectively.

FIG. 12 is a block diagram illustrating one configuration of a harmonic analysis module 1222. The harmonic analysis module 1222 may perform harmonic analysis of noisy and incomplete spectrum using peaks. The harmonic analysis module 1222 may be one example of the harmonic analysis module 322 described in connection with FIG. 3. The harmonic analysis module 1222 may utilize a speech spectrum signal 1209 for pitch detection and tracking. Examples of the speech spectrum signal 1209 include an audio signal, a noise-suppressed audio signal and an isolated-peak suppressed audio signal as described above.

The harmonic analysis module 1222 may include a peak tracking module 1294, a peak pruning module 1296, a harmonic matching module 1298, a voicing state updating module 1201, a pitch tracking module 1203, a non-harmonic peak detection module 1205 and/or frame delay modules 1207a-b. The harmonic analysis module 1222 may perform peak tracking and pruning to obtain reliable information (e.g., refined peaks, reliable peaks, etc.). For example, the harmonic analysis module 1222 may exclude certain peaks. In some configurations, the peak tracking module 1294 may determine the location (e.g., frequency) of one or more peaks in the speech spectrum signal 1209.

The peak tracking module 1294 may determine and/or track one or more peaks in the speech spectrum signal 1209. For example, the peak tracking module 1294 may determine local maximums in the speech spectrum signal 1209 as peaks. In some configurations, the peak tracking module 1294 may smooth the speech spectrum signal 1209. For example, the speech spectrum signal 1209 may be filtered (e.g., low-pass filtered) to obtain a smoothed spectrum.

The peak tracking module 1294 may obtain non-harmonic peaks (e.g., locations) from a previous frame from frame delay module A 1207a. The peak tracking module 1294 may compare any detected peaks in the current frame to the non-harmonic peaks (e.g., locations) from the previous frame. The peak tracking module 1294 may designate any peaks in the current frame that correspond to the non-harmonic peaks from the previous frame as continuous non-harmonic peaks.

The peak tracking module 1294 may provide the peak locations, may provide the smoothed spectrum and/or may indicate the continuous non-harmonic peaks to the peak pruning module 1296. The peak tracking module 1294 may also provide the peak locations to the non-harmonic peak detection module 1205.

The non-harmonic peak detection module 1205 may detect one or more of the peaks (at the peak locations) that are non-harmonic peaks. For example, the non-harmonic peak detection module 1205 may utilize a fundamental frequency 1215 (e.g., pitch 0)) to determine which of the peaks are not harmonics of the fundamental frequency. For instance, the non-harmonic peak detection module 1205 may determine one or more peak locations that are not at approximate integer multiples (e.g., within a range of integer multiples) of the fundamental frequency 1215 as non-harmonic peaks. The non-harmonic peak detection module 1205 may provide the non-harmonic peaks (e.g., locations) to frame delay module A 1207a. Frame delay module A 1207a may provide the non-harmonic peaks (e.g., locations) to the peak tracking module 1294. In other words, the non-harmonic peaks (e.g., locations) provided to the peak tracking module 1294 may correspond to a previous frame.

The peak pruning module 1296 may remove one or more peaks (from the speech spectrum signal 1209, for example) that meet one or more criteria. For example, the peak pruning module 1296 may exclude peaks that are too small relative to a strongest peak and the smoothed spectrum, may exclude peaks with too low tonality (based on a difference from a standard peak template), may exclude peaks that are too close to stronger peaks (e.g., less than a lower limit of f₀) and/or may exclude peaks that are continuous from non-harmonic peaks of the previous frame.

In some configurations, the peak pruning module 1296 may remove any peaks with amplitudes that are less than a particular percentage of the amplitude of the strongest peak (e.g., the peak with the highest amplitude for the frame of the speech spectrum signal 1209) and/or that are within a particular amplitude range of the smoothed spectrum. Additionally or alternatively, the peak pruning module 1296 may remove any peaks with tonality below a tonality threshold. For example, peaks that differ beyond an amount from a peak template may be removed. Additionally or alternatively, the peak pruning module 1296 may remove any peaks that are within a particular frequency range from a stronger peak (e.g., a neighboring peak with a high amplitude). Additionally or alternatively, the peak pruning module 1296 may remove any peaks that are continuous from non-harmonic peaks of the previous frame. For example, peaks indicated by the peak tracking module 1294 as being continuous from non-harmonic peaks of the previous frame may be removed.

The peaks remaining after peak pruning may be referred to as refined peaks 1211 (e.g., “pruned peaks” or “reliable peaks”). The refined peaks 1211 may be provided to the harmonic matching module 1298. In some configurations, the refined peaks 1211 may include refined peak locations (e.g., fₗ), refined peak amplitudes (e.g., Aₗ) and/or refined peak phases (e.g., φₗ).

The harmonic matching module 1298 may perform harmonic matching for finding the fundamental frequency (e.g., f₀). For example, the harmonic matching module 1298 may find the fundamental frequency with only a few refined peaks 1211 (e.g., fₗ), where the fundamental frequency (e.g., f₀) is the generalized greatest common divisor for the refined peaks 1211 (e.g., the fractional part of f₀), denoted {fₗ/f₀}ᵣ, as small as possible for each fₗ). For example,

$${f}_{0} = {arg max}_{{f}_{0}} \tilde{M} ( {f}_{0} ) .$$

This may be utilized to find f₀ that best matches the observed peak frequencies {fₗ} in the sense that f₀ makes each {f₁/f₀}, as small as possible over a given range for f₀. \tilde{M}(f₀) denotes the harmonic matching spectrum (e.g., a weighted harmonic matching score), where \tilde{M}(f₀)=Σₗw(A₁)g(fₗ/f₀}ᵣ). This is a sum of harmonic matching scores for peaks fₗ weighted by their amplitudes Aₗ. In some configurations, the weighting function is w(A₁)=Aₗ^{0.5}, which provides a weight for amplitude. g({fₗ/f₀}ᵣ) denotes a harmonic matching measure, which may be

$$g ( {\{ {f}_{1} / {f}_{0} \}}_{r} ) = \frac{1}{( 1 + {e}^{30 ( {\{ {f}_{1} / {f}_{0} \}}_{r} - 0.2 )} )} ,$$

for example. This provides a score between 0 and 1, which reflects the extent to which fₗ/f₀ is close to some integer. The harmonic matching module 1298 may provide the harmonic matching spectrum (e.g., \tilde{M}(f₀)) to the pitch tracking module 1203. The harmonic matching module 1298 may provide the harmonic matching measure (e.g., g({fₗ/f₀}ᵣ)).

The voicing state updating module 1201 may perform voicing state classification as follows. In some configurations, there may be three voicing states: non-voice (e.g., V(t)=0), voiced-sustained (e.g., V(t)=1) and voiced-onset (e.g., V(t)=0.5). This may allow different strategies for non-voice, voiced-sustained and voiced-onset (and/or silent) portions of speech and dynamic pitch variance control.

State tracking from frame to frame may be performed as follows in some configurations. Low band harmonic energy may be based on the detected fundamental frequency (e.g., f₀) below a cutoff frequency (e.g., f_{cutoff}). For example, M̅(f₀)=τ_{f}_{ₗ}_{<f}_{_{cuttoff}}Aₗg({fₗ/f₀}ᵣ). In some configurations, f_{cutoff}=1 kilohertz (kHz).) The voicing state updating module 1201 may initialize a tracking count (at 0, for example). The tracking count may be increased (by 1, for example) if M̅(f₀) is greater than a predetermined threshold. The tracking count may be limited to 3. For example, if increasing the tracking count would make the tracking count greater than 3, then the tracking count may not be increased, but may be limited to 3. The tracking count may be decreased (by 1, for example) if M̅(f₀) is less than or equal to a predetermined threshold (e.g., the same as or different from the predetermined threshold used for increasing the tracking count). The tracking count may be limited to 0. For example, if decreasing the tracking count would make the tracking count less than 0, then the tracking count may not be decreased, but may be limited to 0.

The tracking count may be mapped to voicing states as follows. If the tracking count=0, then the voicing state may be non-voice (e.g., V(t)=0), indicating a non-voiced frame. If the tracking count=1 in the current frame and the tracking count=0 in the previous frame, then the voicing state may be voiced-onset (e.g., V(t)=0.5), indicating a voice onset in a frame. In other cases, the voicing state may be voiced-sustained (e.g., V(t)=1), indicating sustained voice in a frame. In some configurations, the tracking count may be limited to [0, 1, 2, 3]: 0 for non-voiced, 3 for voiced-sustained and 1 and 2 for voiced-onset. The voicing state updating module 1201 may provide the voicing state (indicating non-voice, voiced-onset or voiced-sustained, for example) to the pitch tracking module 1203.

The pitch tracking module 1203 may perform pitch tracking for a continuous contour. This may be referred to as “dynamic pitch variance control.” The pitch tracking module 1203 may compute and/or utilize a pitch difference measure. The pitch difference measure may be a measure of pitch changing rate from frame to frame. In some configurations, the pitch difference measure may be in the logarithmic domain. For example, the pitch difference measure may be denoted d_{f}_{₀} (0=|log₂(f₀(t)/f₀(t−1))|. An adaptive pitch search range may be monotonically decreasing as the number of consecutive voiced frames (e.g., V(t)>0) increases up to the current frame increases. For example, the adaptive pitch search range may gradually shrink while going deeper into voiced segments (from 1.5 to 0.4 in 5 frames, for instance). Pitch candidates may be a number of the largest peaks of the harmonic matching spectrum. For example, the pitch candidates may be the three largest peaks of \tilde{M}(f₀), covering halving and doubling. The pitch tracking module 1203 may utilize forward path tracking to maximize sustained harmonic energy. For example, the pitch tracking module 1203 may determine the fundamental frequency 1215

$$( e . g . , pitch ) as {f}_{0} ( t ) = {arg max}_{{f}_{0} ( t )} \{ {\tilde{M}}_{t}^{3} ( {f}_{0} ( t ) ) - 0.25 {d}_{{f}_{0}} ( t ) {\tilde{M}}_{t - 1}^{3} ( {f}_{0} ( t - 1 ) ) \} .$$

As illustrated in FIG. 12, the fundamental frequency 1215 (e.g., pitch) may be provided to the non-harmonic peak detection module 1205 and to frame delay module B 1207b. The non-harmonic peak detection module 1205 may utilize the fundamental frequency 1215 to detect one or more non-harmonic peaks as described above. Frame delay module B 1207b may delay the fundamental frequency 1215 by a frame. In other words, frame delay module B 1207b may provide the fundamental frequency from a previous frame (e.g., f₀(t−1)) to the pitch tracking module 1203. The pitch tracking module 1203 may utilize the fundamental frequency from the previous frame to compute a pitch difference measure as described above.

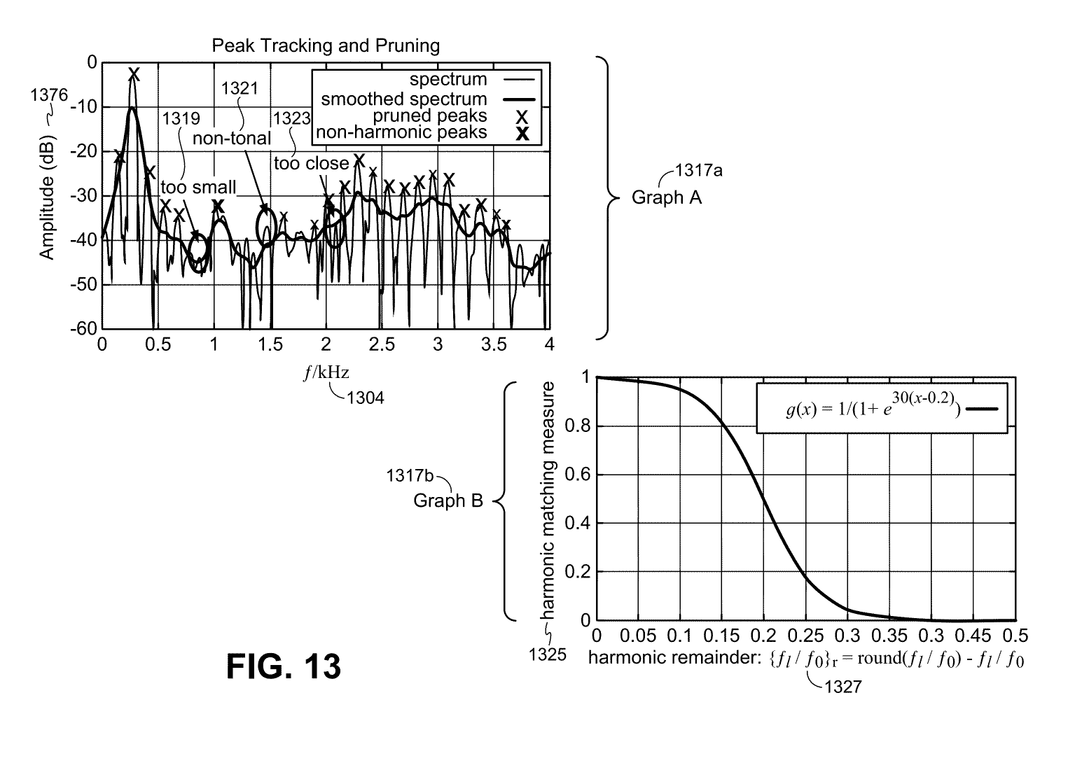

FIG. 13 includes graphs 1317a-b that illustrate an example of harmonic analysis in accordance with the systems and methods disclosed herein. Graph A 1317a illustrates examples of peaks that are pruned based on the criteria described in connection with FIG. 12. In particular, graph A 1317a illustrates examples of peaks that are removed because they are too small 1319, non-tonal 1321 or too close 1323 to another peak. Graph B 1317b illustrates an example of a harmonic matching measure 1325 over a harmonic remainder 1327.

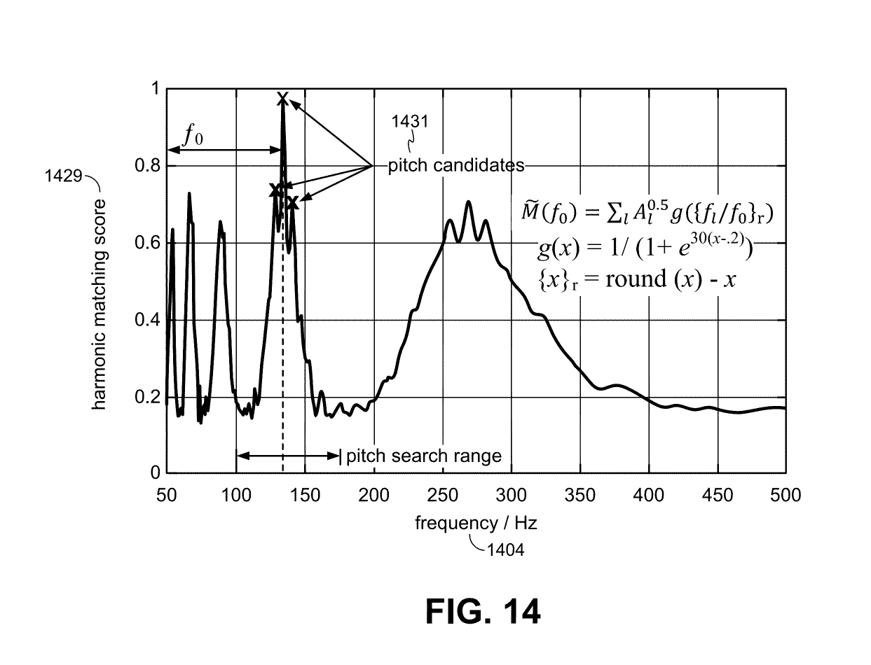

FIG. 14 includes a graph that illustrates an example of pitch candidates 1431. In particular, the graph illustrates an example of a harmonic matching score 1429 over frequency (Hz) 1404. The pitch candidates 1431 may be obtained as described in connection with FIG. 12. In particular, FIG. 14 illustrates pitch candidates 1431 in a pitch search range.

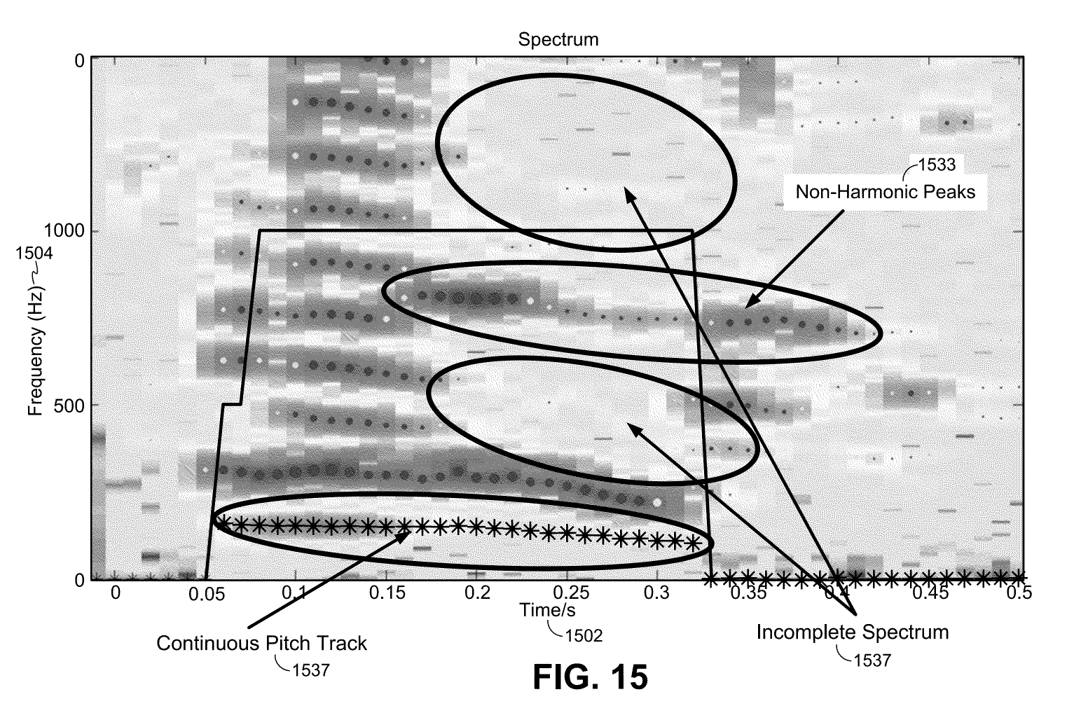

FIG. 15 includes a graph that illustrates an example of harmonic analysis in accordance with the systems and methods disclosed herein. In particular, FIG. 15 includes examples of a continuous pitch track 1535 and non-harmonic peaks 1533 that may be determined as described in connection with FIG. 12. For example, the graph illustrates that non-harmonic peaks 1533 may occur in between harmonic partials (for musical noise, for example). FIG. 15 also illustrates incomplete spectrum 1537 (e.g., missing partials).

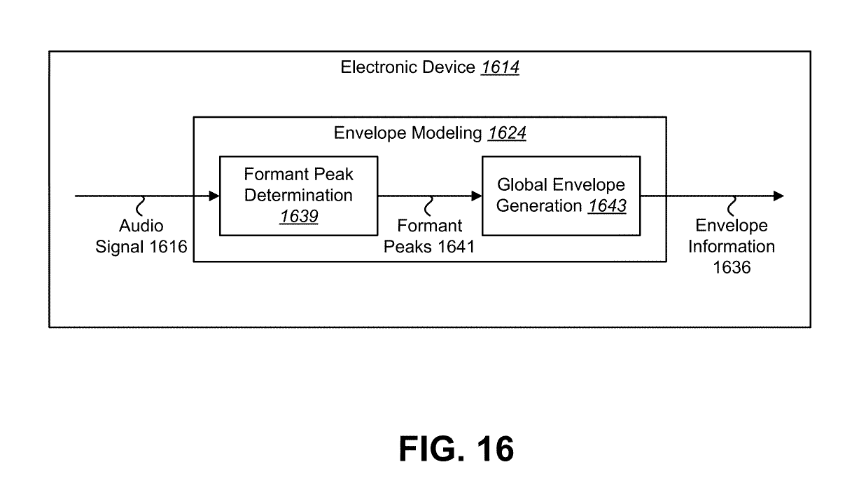

FIG. 16 is a block diagram illustrating another configuration of an electronic device 1614 in which systems and methods for enhancing an audio signal 1616 may be implemented. Examples of the electronic device 1614 include cellular phones, smartphones, tablet devices, voice recorders, laptop computers, desktop computers, landline phones, camcorders, still cameras, in-dash electronics, game systems, televisions, appliances, etc. One or more of the components of the electronic device 1614 may be implemented in hardware (e.g., circuitry) or a combination of hardware and software.

The electronic device 1614 may include an envelope modeling module 1624. The envelope modeling module 1624 described in connection with FIG. 16 may perform one or more of the functions and/or procedures described in connection with the envelope modeling module 324 described in connection with FIG. 3. For instance, the envelope modeling module 1624 described in connection with FIG. 16 may be one example of the envelope modeling module 324 described in connection with FIG. 3. It should be noted that the envelope modeling module 1624 may only operate on voiced frames in some configurations. For example, the envelope modeling module 1624 may receive a voicing state (e.g., V(t)). If the voicing state indicates a voiced frame (e.g., voiced-sustained frame or voiced-onset frame), the envelope modeling module 1624 may generate a global envelope. However, if the voicing state indicates a non-voiced frame, the envelope modeling module 1624 may not operate on (e.g., may bypass) the non-voiced frame. In some configurations, the voicing state may be provided by a known voice activity detector (e.g., VAD). In other configurations, the envelope modeling module 1624 may receive the voicing state from a harmonic analysis module as described above.

The envelope modeling module 1624 may include a formant peak determination module 1639 and/or a global envelope generation module 1643. The formant peak determination module 1639 may determine formant peaks 1641 based on the audio signal 1616. In some configurations, the formant peak determination module 1639 may obtain spectral information (e.g., peak locations, peak amplitudes and/or a fundamental frequency) based on the audio signal 1616. In other configurations, the formant peak determination module 1639 may receive spectral information based on the audio signal 1616. For example, the formant peak determination module 1639 may receive refined peak locations (e.g., fₗ), refined peak amplitudes (e.g., Aₗ) and/or a fundamental frequency (e.g., f₀(t)) from a harmonic analysis module.

In some configurations, the formant peak determination module 1639 may determine the formant peaks 1641 as a number (e.g., 3-4) of the largest peaks (e.g., local maxima) of the refined peaks. However, it should be noted that the formant peak determination module 1639 may determine the formant peaks 1641 directly from the audio signal 1616, the noise-suppressed audio signal or the isolated peak-suppressed audio signal in other configurations. The formant peaks 1641 may be provided to the global envelope generation module 1643.

The global envelope generation module 1643 may generate formant peak models. Each of the formant peak models may be formant peak envelopes (over a spectrum, for example) that model a formant peak. Generating the formant peak models may include individually modeling each formant peak. For example, the global envelope generation module 1643 may utilize one or more model types to individually model each formant peak. Some examples of model types that may be utilized to generate the formant peak models include filters, all-pole models (where all-poles models resonate at the formant peak), all-zero models, autoregressive-moving-average (ARMA) models, etc. It should be noted that different order models may be utilized. For example, all-pole models may be second-order all-pole models, third-order all-pole models, etc.

In some configurations, individually modeling each formant peak may include determining whether each formant peak is supported. A formant peak may be supported if there are neighboring peaks (at neighboring harmonics, for example). A formant peak may be unsupported if one or more neighboring peaks (at neighboring harmonics, for example) are missing.

Individually modeling each formant peak may also include selecting a modeling type for each formant peak based on whether each respective formant peak is supported. For example, the global envelope generation module 1643 may model one or more supported formant peaks with a first modeling (e.g., local-matching two-pole modeling) and/or may model one or more unsupported formant peaks with a second modeling (e.g., fixed-p two-pole modeling).

In some configurations, the global envelope generation module 1643 may perform dominant local all-pole modeling of an envelope from incomplete spectrum. For example, the global envelope generation module 1643 may use formant peaks (e.g., only formant peaks) for local all-pole modeling.

The global envelope generation module 1643 may generate a global envelope (e.g., H(f)) based on the formant peak models. For example, the global envelope generation module 1643 may determine formant peak models (e.g., envelopes) and merge the formant peak models to produce the global envelope of the frame (e.g., voiced frame). This may produce an envelope from highly incomplete spectral information. In some configurations, the global envelope generation module 1643 may concatenate the formant peak models to produce the global envelope. Additionally or alternatively, the global envelope generation module 1643 may perform a maximum (e.g., “max”) operation on the formant peak models. For example, the global envelope generation module 1643 may merge separate envelopes from the local all-pole modeling based on the max operation. For instance, the maximum amplitude of all the formant peak models (e.g., envelopes) over the spectrum may yield a max envelope. This may maintain local consistency at formant peaks and nearby. In some configurations, discrete-all-pole (DAP) modeling may be performed on the max envelope to yield the global envelope. In other configurations, the max envelope may be smoothed with a smoothing filter or a smoothing algorithm to yield the global envelope. In yet other configurations, the max envelope itself may be utilized as the global envelope.

In some configurations, the global envelope generation module 1643 may perform missing partial prediction. For example, the global envelope generation module 1643 may determine missing partials at harmonic frequencies of the fundamental frequency (e.g., at fₖ=kf₀, where k is a set of integers). The global envelope generation module 1643 may determine the missing partial amplitudes as the magnitudes (e.g., absolute values) of the global envelope at each of the harmonic frequencies (e.g., Aₖ=|H(fₖ)|). The global envelope generation module 1643 may also determine the missing partial minimum phases (e.g., φₖ^{m}=arg H(fₖ)).

The global envelope generation module 1643 may provide envelope information 1636. In some configurations, the envelope information 1636 may include the global envelope (e.g., H(f)). Additionally or alternatively, the envelope information 1636 may include extended peak information (e.g., harmonic frequencies fₖ, missing partial amplitudes Aₖ and/or missing partial minimum phases φₖ^{m}). For instance, the envelope information 1636 may include H(f), fₖ, Aₖ and/or φₖ^{m}.

In some configurations, the electronic device 1614 may generate a time-domain speech signal based on the envelope information 1636 (e.g., the global envelope). Additionally or alternatively, the electronic device 1614 may transmit one or more of the formant peak models (e.g., one or more parameters representing the formant peak model(s)). In some configurations, the formant peak model(s) (and/or parameters based on the formant peak model(s)) may be quantized. For example, vector quantization and/or one or more codebooks may be utilized to perform the quantization.

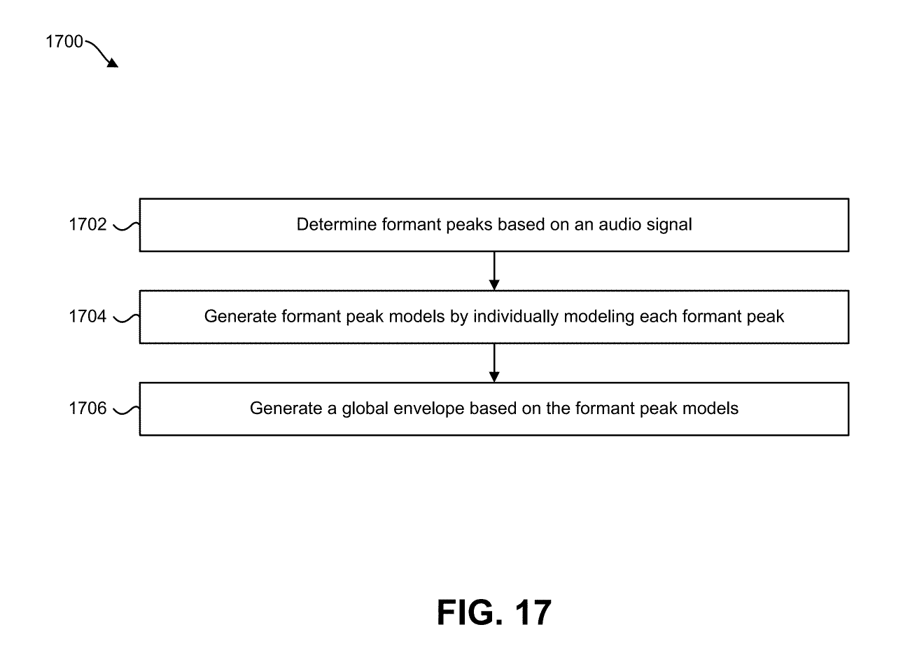

FIG. 17 is a flow diagram illustrating one example of a method 1700 for enhancing an audio signal 1616. An electronic device 1614 may determine 1702 formant peaks 1641 based on an audio signal 1616. This may be accomplished as described above in connection with FIG. 16. For example, the electronic device 1614 may select a number of the largest peaks (e.g., peaks with the highest amplitudes) from a set of peaks (e.g., refined peaks).

The electronic device 1614 may generate 1704 formant peak models by individually modeling each formant peak. This may be accomplished as described above in connection with FIG. 16. For example, the electronic device 1614 may determine whether each formant peak is supported and may select a modeling type based on whether each respective formant peak is supported.

The electronic device 1614 may generate 1706 a global envelope based on the formant peak models. This may be accomplished as described above in connection with FIG. 16. For example, the electronic device 1614 may merge (e.g., concatenate, perform a max operation on, etc.) the formant peak models. In some configurations, the electronic device 1614 may perform one or more additional operations (e.g., DAP modeling, filtering, smoothing, etc.) on the merged envelope. In some configurations, the electronic device 1614 may not merge formant peak models (e.g., envelopes) in the case where only one formant peak is detected.

As described above, the electronic device 1614 may generate a time-domain speech signal based on the envelope information 1636 (e.g., the global envelope) in some configurations. Additionally or alternatively, the electronic device 1614 may transmit one or more of the formant peak models (e.g., one or more parameters representing the formant peak model(s)).

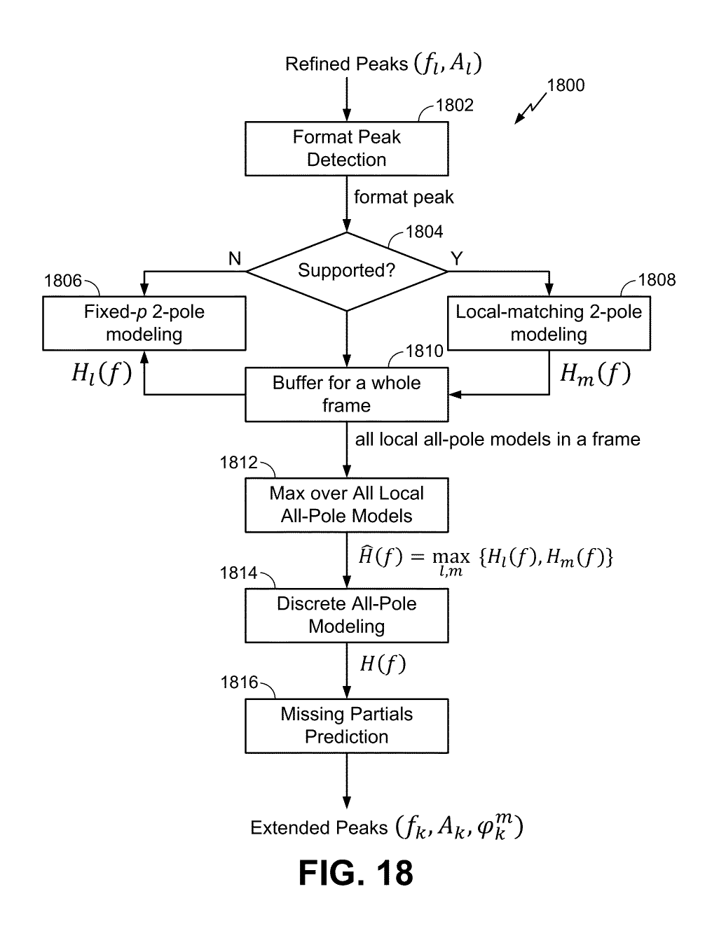

FIG. 18 is a flow diagram illustrating a more specific configuration of a method 1800 for enhancing an audio signal. For example, FIG. 18 illustrates an example of an approach for dominant local all-pole modeling of an envelope from incomplete spectrum. For example, FIG. 18 illustrates an example of local all-pole modeling or envelope modeling by dominant peaks.

The electronic device 1614 may perform 1802 formant peak detection. This may be accomplished as described in connection with one or more of FIGS. 3 and 16-17. For example, formant peaks may be the largest three to four local maxima of refined peaks (e.g., {fₗ}). These may be significant and stable voiced features.

The electronic device 1614 may determine 1804 whether each formant peak is isolated (e.g., unsupported) or supported. Isolated formant peaks (e.g., (fₗ, Aₗ)) may have at least one missing peak at neighboring harmonic positions (of fₗ, for example). In this case, the electronic device 1614 may apply 1806 a fixed-p 2-pole modeling with a preset pole strength (e.g., 20 dB/200 Hz, p=0.9843). For example, fixed-p 2-pole modeling may provide

$${H}_{I} ( f ) = \frac{{A}_{I} ( 1 - p ) \vert 1 - p {e}^{- j2 {f}_{I}} \vert}{( 1 - p {e}^{- j ( f - {f}_{I} )} ) ( 1 - p {e}^{- j ( f + {f}_{I} )} )} .$$

Additionally or alternatively, the electronic device 1614 may utilize a local 1-pole filter with preset pole strength (20 dB/200 Hz, p=0.9843). For example,

$${H}_{I} ( f ) = \frac{{A}_{I} ( 1 - {p}_{I} )}{( 1 - {p}_{I} {e}^{- j ( f - {f}_{I} )} )}$$

for isolated formant peaks (Aₗ, fₗ).

Supported formant peaks (e.g., (f_{l±1,0}, A_{l+1,0})) may include both peaks at neighboring harmonic positions of a present fₗ. In this case, the electronic device 1614 may apply 1808 local matching 2-pole modeling to match three consecutive peaks by solving (Fₘ, pₘ, αₘ) as provided by

$${H}_{m} ( f ) = \frac{{α}_{m} ( 1 - {p}_{m} ) \vert 1 - {p}_{m} {e}^{- j2 {F}_{m}} \vert}{( 1 - {p}_{m} {e}^{- j ( f - {F}_{m} )} ) ( 1 - {p}_{m} {e}^{- j ( f + {F}_{m} )} )} .$$

Additionally or alternatively, the electronic device 1614 may utilize a 1-pole filter to match three consecutive peaks (solved by a closed form approximation formula, for example).

The electronic device 1614 may buffer 1810 each formant peak model for all formant peaks in a frame, whether supported or isolated (e.g., unsupported). For the set of formant peak models, the electronic device 1614 may determine 1812 a max envelope based on the corresponding all-pole models. For example, at each frequency, the strongest local all-pole model is used in accordance with a max operation or a L^{p}-norm operation. This may maintain consistency in the formant regions. For instance, the max envelope may be provided in accordance with Ĥ(f)=max_{I,m}{H_{I}(f), Hₘ(f)}.

The electronic device 1614 may perform 1814 global all-pole modeling based on the max envelope. For example, the electronic device 1614 may perform 1814 discrete all-pole (DAP) modeling. For instance, the electronic device 1614 may determine an all-pole filter H(f) that minimizes the Itakura-Saito distance (D_{I-S}(x, y)) with the max envelope Ĥ(f) across all harmonic frequencies fₖ (e.g., between the spectral response and the merged envelope). This may be provided by

$$H ( f ) = {arg min}_{H ( f )} {\sum }_{k} {D}_{I - S} ( H ( {f}_{k} ) , \hat{H} ( {f}_{k} ) ) .$$

The electronic device 1614 may perform 1816 missing partials prediction. For example, the electronic device 1614 may determine a missing partial at fₖ=kf₀ with amplitude Aₖ=|H(fₖ)| and minimum phase φₖ^{m}=arg H(fₖ). In other words, the electronic device 1614 may determine extended peaks (e.g., harmonic frequencies fₖ, missing partial amplitudes Aₖ and/or missing partial minimum phases φₖ^{m}). In some configurations, the electronic device 1614 may utilize linear predictive coding (LPC) coefficients (αₘ) for a smooth spectral envelope and minimal phase (φ^{m}).

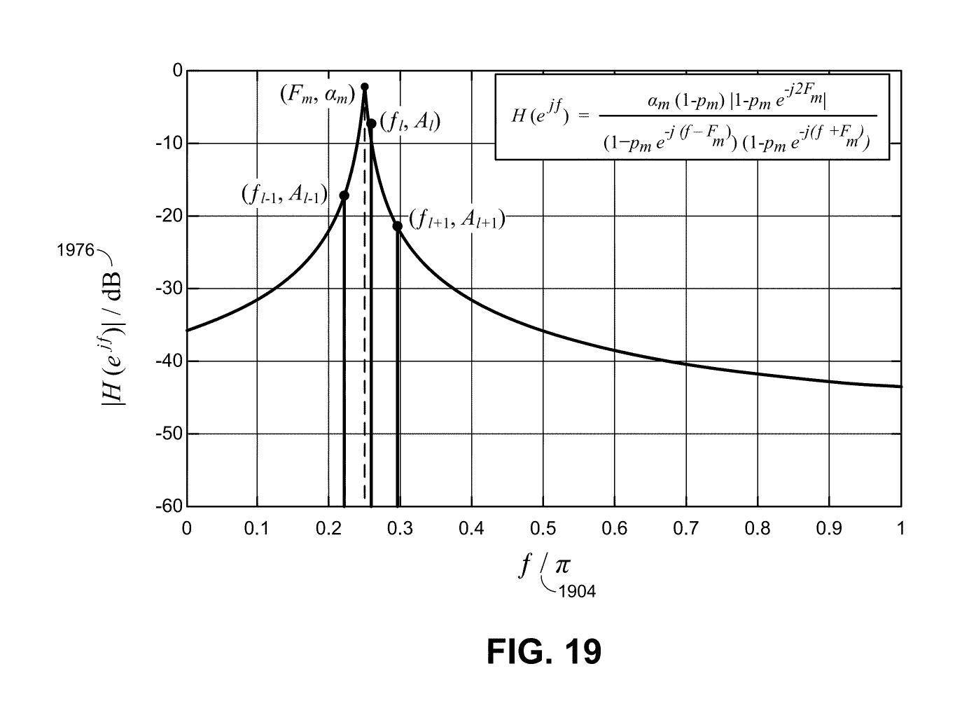

FIG. 19 includes a graph that illustrates one example of all-pole modeling in accordance with the systems and methods disclosed herein. The graph is illustrated in amplitude (dB) 1976 over frequency (radians) 1904. For instance, FIG. 19 illustrates one example of 2-pole modeling for a supported formant peak as described in connection with FIG. 18.

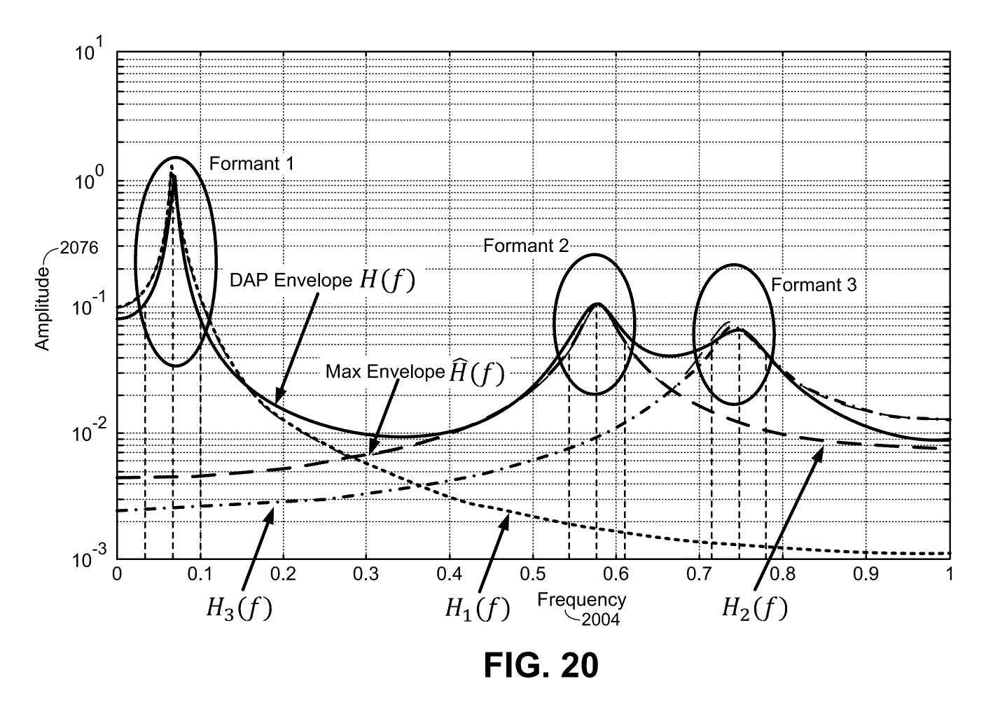

FIG. 20 includes a graph that illustrates one example of all-pole modeling with a max envelope in accordance with the systems and methods disclosed herein. The graph is illustrated in amplitude 2076 over frequency 2004. For instance, FIG. 20 illustrates one example a max envelope for three formants as described in connection with FIG. 18. For example, H₃(f) may be one example of a local model for formant 3, H₁(f) may be one example of a local model for formant 1 and H₂(f) may be one example of a local model for formant 2.

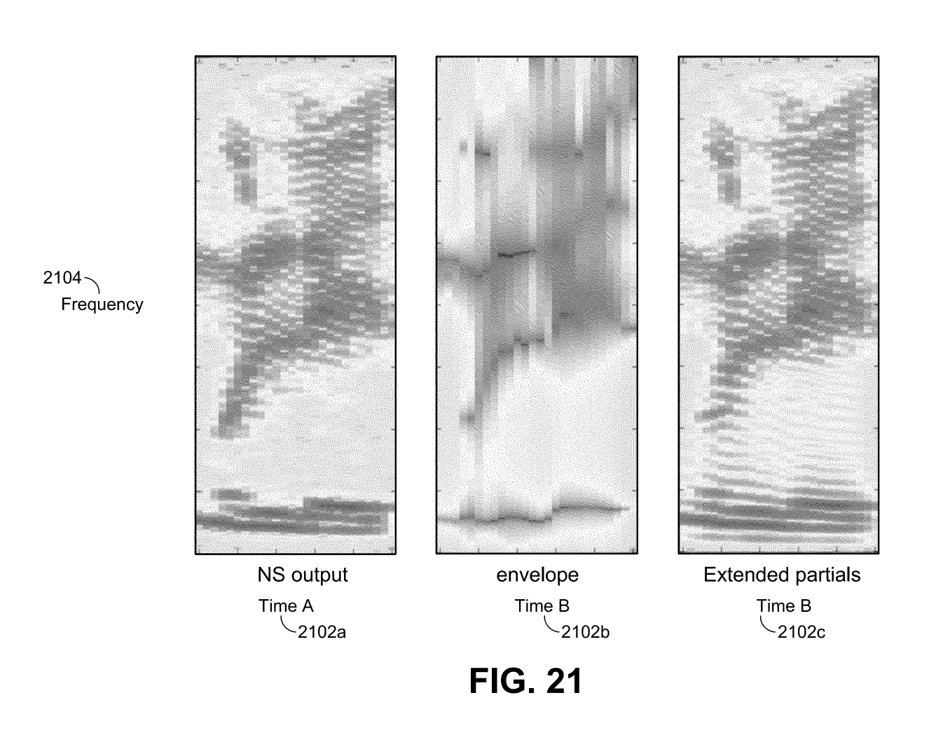

FIG. 21 includes graphs that illustrate one example of extended partials in accordance with the systems and methods disclosed herein. The graphs are illustrated in frequency 2104 over time A 2102a, time B 2102b and time C 2102c. For instance, FIG. 21 illustrates one example of a noise suppression output, its corresponding envelope and resulting extended partials as described in connection with FIG. 18.

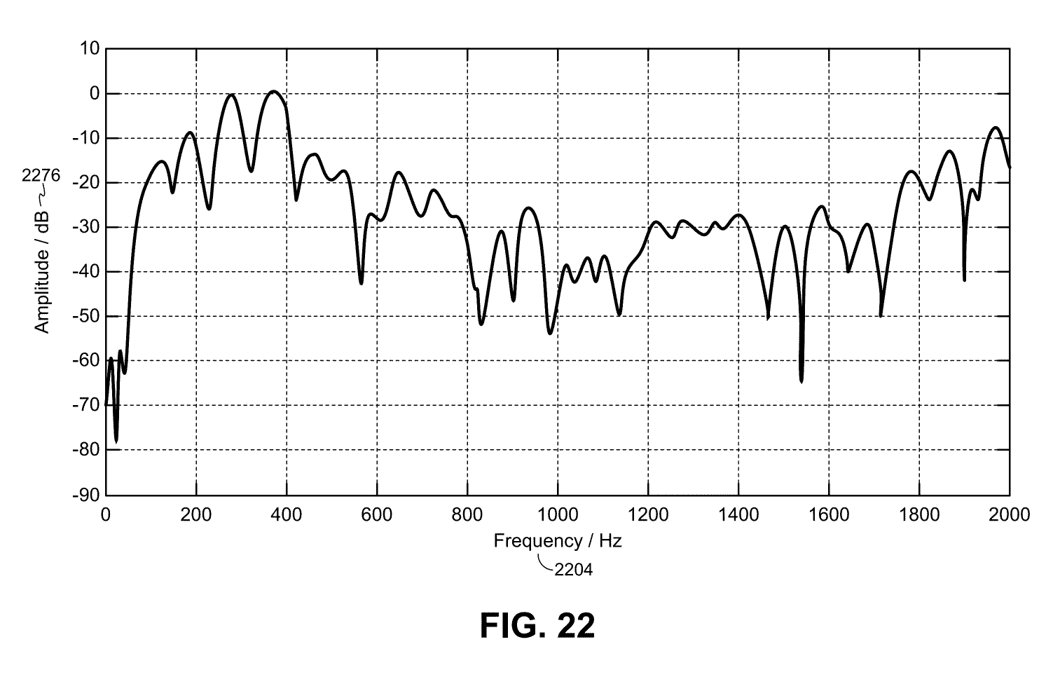

FIGS. 22-31 provide additional detail regarding envelope modeling (e.g., examples of processing flow of envelope modeling). For instance, one or more of the procedures described in FIGS. 22-31 may be performed by one or more of the envelope modeling modules 324,1624 described in connection with one or more of FIGS. 3 and 16 and/or may be examples of, may be performed in conjunction with and/or may be performed instead of the envelope modeling functions described above (in one or more of FIGS. 3-4 and 16-20, for example). In some configurations, one or more of the procedures described in connection with FIGS. 22-31 may be combined with one or more of the other functions described above (e.g., noise suppression, isolated peak suppression, harmonic analysis and/or phase synthesis). Alternatively, one or more of the procedures described in connection with FIGS. 22-31 may be performed independently from the other functions, procedures and/or modules described above.

FIG. 22 is a graph illustrating one example of a spectrum of a speech signal (e.g., recorded speech signal) corrupted by noise. The graph in FIG. 22 is illustrated in amplitude (dB) 2276 over a frequency spectrum (Hz) 2204.

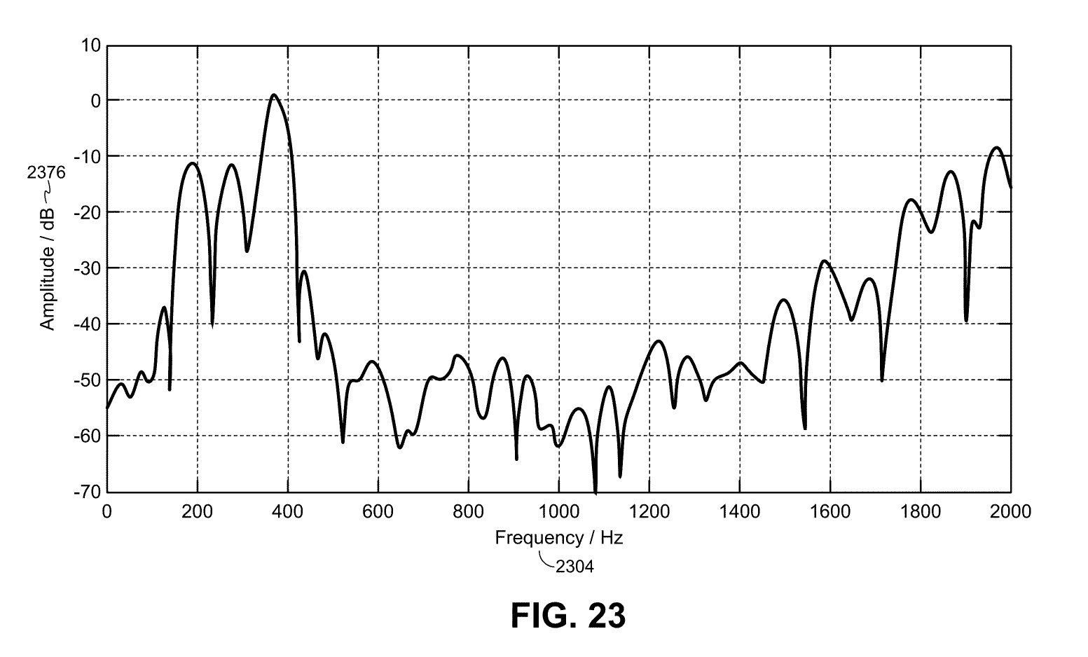

FIG. 23 is a graph illustrating one example of a spectrum of a speech signal (e.g., recorded speech signal) corrupted by noise after noise suppression. The graph in FIG. 23 is illustrated in amplitude (dB) 2376 over a frequency spectrum (Hz) 2304. As illustrated in FIG. 23, when a speech signal (e.g., a recorded speech signal) is too noisy after noise suppression, a weak part of a spectrum may be completely or almost completely gone. For instance, the band from 400 Hz to 1400 Hz is significantly attenuated. Restoring the missing spectral components in this band may improve speech quality and intelligibility.

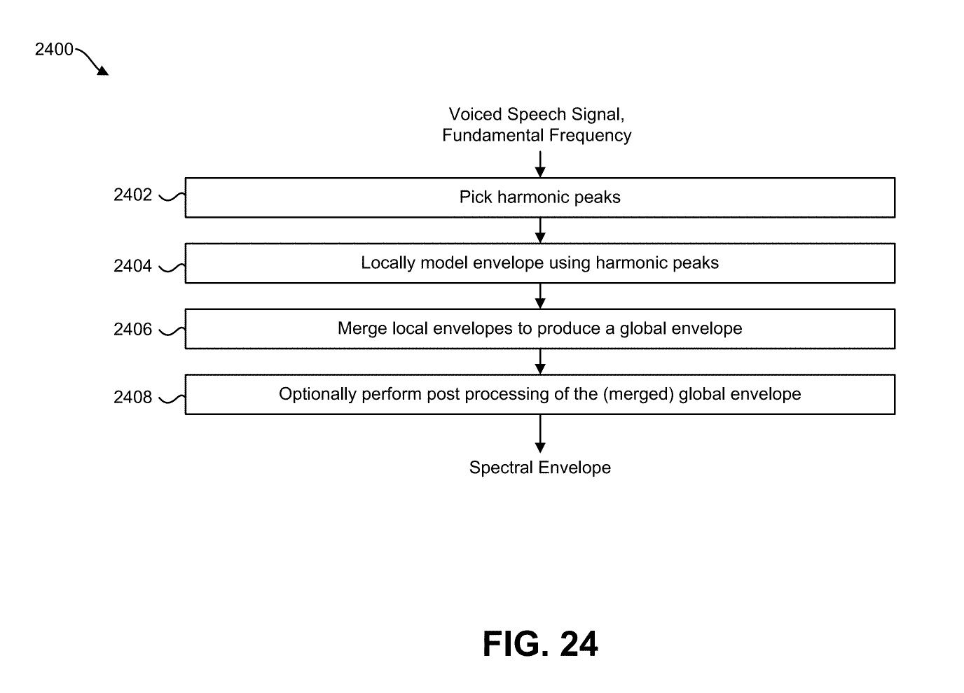

FIG. 24 is a flow diagram illustrating an example of a method 2400 for envelope modeling. For example, the method 2400 may be an approach for modeling an envelope as described in connection with one or more of FIGS. 16-18. The method 2400 may take an input of a voiced speech signal (e.g., audio signal 1616) and the corresponding fundamental frequencies. In some configurations, the voiced speech signal does not include significant noisy and inharmonic peaks in the frequency domain. For example, the voiced speech signal may be a noisy speech recording after noise suppression, isolated peak suppression, non-harmonic peak suppression/removing and/or other cleanup preprocessing. But such a voiced speech signal may lack substantial spectral components in some bands compared to clean speech. An example of such a voiced speech signal is given in FIG. 23.

An electronic device 1614 may pick 2402 harmonic peaks. For example, a clean voiced speech signal has spectral peaks evenly spaced by the fundamental frequency. Frequencies of the spectral peaks may be referred to as harmonic frequencies and the corresponding spectral peaks may be referred to as harmonic peaks.

The electronic device 1614 may locally model 2404 envelope(s) (e.g., individually model formant peaks) using harmonic peaks. The electronic device 1614 may merge 2406 local envelopes to produce a global envelope. The electronic device 1614 may optionally perform 2408 post processing of the (merged) global envelope. This may produce a spectral envelope. One or more of these procedures may be accomplished as described above in connection with one or more of FIGS. 16-18.

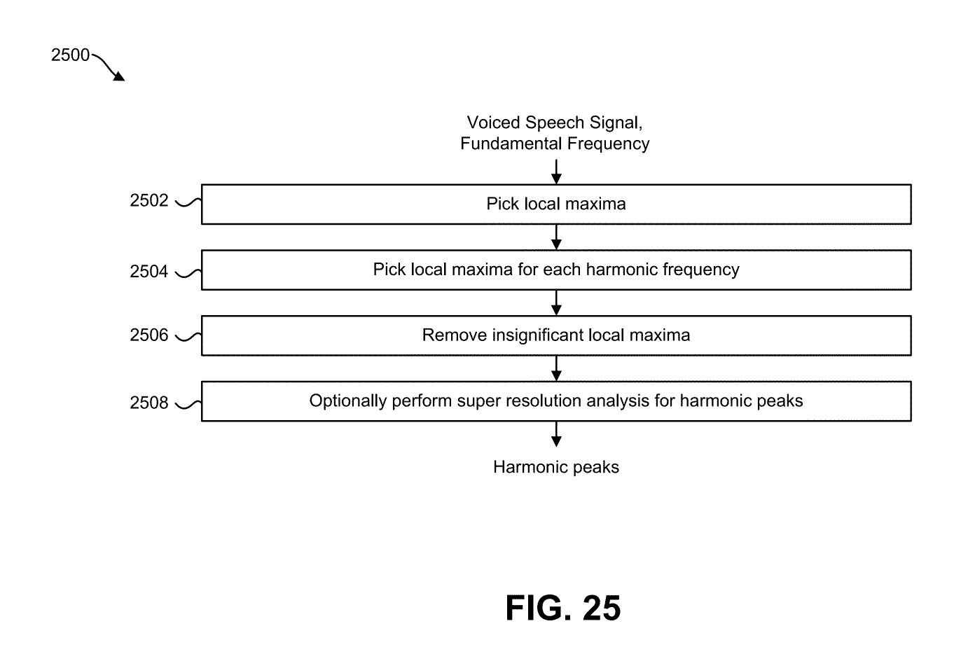

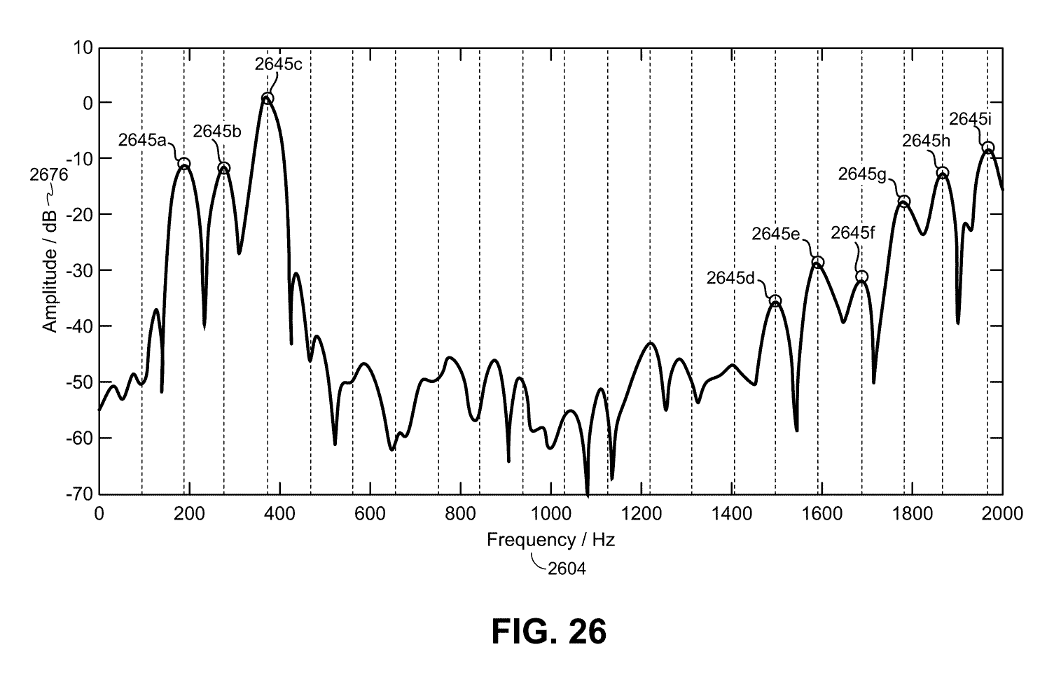

FIG. 25 is a flow diagram illustrating one configuration of a method 2500 for picking harmonic peaks. In particular, FIG. 25 illustrates one approach for picking harmonic peaks as described in connection with FIG. 24. To pick harmonic peaks, for example, the electronic device 1614 may first pick 2502 local maxima (e.g., frequency bins larger than their immediate neighboring left and right bins). Then for each harmonic frequency, the electronic device 1614 may pick 2504 the local maxima closest or strongest to this harmonic frequency within a search range of consecutive frequency bins including the harmonic frequency. For some harmonic frequencies, there may be no harmonic peaks due to no local maxima within the search range. Also, even a harmonic peak exists, if it is too low (e.g., lower than human's hearing threshold), it may be removed 2506 from the harmonic peak sets. This is shown in FIG. 26. Out of 21 harmonic frequencies from 0 Hz to 2000 Hz, only 9 harmonic peaks are picked. In particular, FIG. 26 illustrates an example of picked harmonic peaks 2645a-i over harmonic frequencies (indicated by dashed vertical lines).

The electronic device 1614 may optionally perform 2508 super resolution analysis for harmonic peaks. For example, it is also possible to improve frequency precision of the harmonic peaks beyond frequency bin resolution (super resolution) by doing interpolation around the harmonic peaks (e.g., using quadratic interpolation). The method 2500 described in connection with FIG. 25 may provide harmonic peaks (e.g., picked or selected harmonic peaks).

FIG. 26 is a graph illustrating one example of a spectrum of a speech signal with picked harmonic peaks 2645a-i. The graph in FIG. 26 is illustrated in amplitude (dB) 2676 over a frequency spectrum (Hz) 2604. Harmonic peaks may be picked or selected as described in connection with FIG. 25. In this example, only 9 harmonic peaks are picked out of 21 harmonic frequencies from 0 Hz to 2000 Hz. In particular, FIG. 26 illustrates an example of picked harmonic peaks 2645ai over harmonic frequencies (indicated by dashed vertical lines).

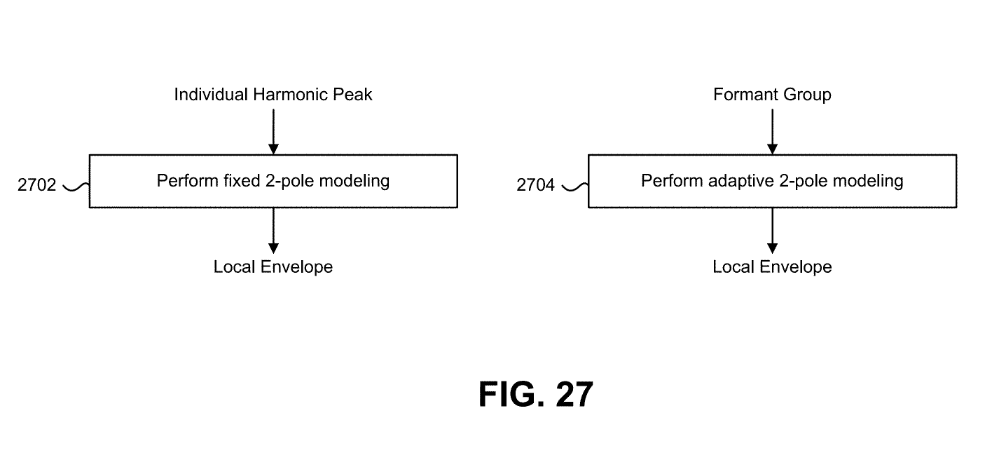

FIG. 27 illustrates examples of peak modeling. In particular, FIG. 27 illustrates locally modeling envelope(s) using harmonic peaks as described in connection with FIG. 24. In particular, FIG. 27 depicts performing 2702 fixed 2-pole modeling based on an individual (e.g., unsupported) harmonic peak to produce a local envelope. FIG. 27 also depicts performing 2704 adaptive 2-pole modeling based on a formant group to produce a local envelope. For example, the electronic device 1614 may perform 2702 fixed 2-pole modeling and/or may perform 2704 adaptive 2-pole modeling.

The harmonic peaks of a clean voiced speech signal usually have different magnitudes, mainly due to vocal tract resonance. The resonance frequencies of the vocal tract are called formant frequencies and spectral contents near the formant frequencies are called formants and may be approximated by an all-pole filter's frequency response.

In order to obtain a global envelope that approximately matches all the harmonic peaks, the electronic device 1614 may begin by performing local matching (e.g., matching individual harmonic peaks or groups of consecutive harmonic peaks, called formant groups hereafter). The locally matched envelopes are called local envelopes (e.g., formant peak models) hereafter. If a harmonic peak is not supported (e.g., if there is no immediate left and/or right neighboring harmonic peaks), this harmonic peak is called an unsupported formant peak. If a harmonic peak is supported (e.g., there are immediate left and right neighboring harmonic peaks), this harmonic peak is called a supported harmonic peak. Within a formant group, the largest supported harmonic peak is called a supported formant peak. It should be noted that, even if harmonic peaks are supported, they may still be viewed as individual harmonic peaks. For example, the electronic device 1614 may model local envelopes for each of the individual harmonic peaks in some configurations, generally, for the benefit of lower system complexity at the cost of higher envelope modeling error.

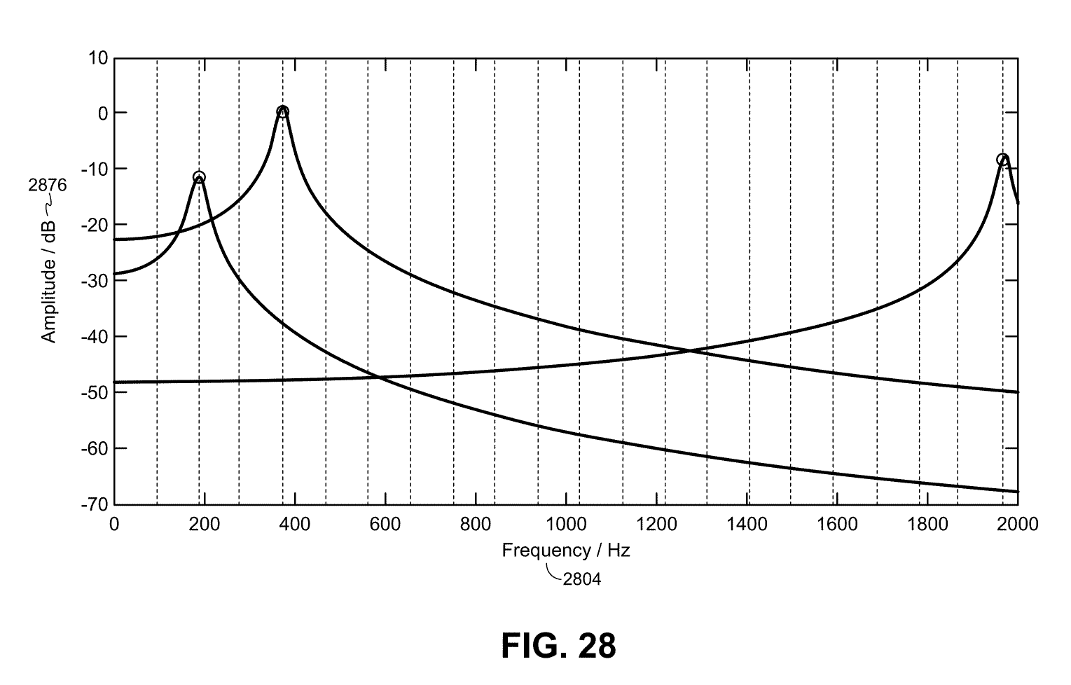

In the case of individual harmonic peaks, one approach to assign a local envelope is to use an all-pole filter frequency response. In some configurations, this all-pole filter can have only 2 poles, which, as complex numbers, conjugate to each other. For the pole with a positive imaginary part, its angle may be set equal to the angular frequency of the interested harmonic peak by the electronic device 1614. Pole strength (e.g., a pole's absolute value) may be set (by the electronic device 1614) to some predetermined number (e.g., 0.98) corresponding to a reasonable formant shape observed in clean speech signals. This 2-pole filter's gain may be set (by the electronic device 1614) to the harmonic peak's amplitude. FIG. 28 provides an illustration of local envelopes modeled by filters, where a filter gain may be set to the harmonic peak amplitude. It should be noted that there are other ways to assign an envelope, as long as they resemble speech formant shapes. Additionally, not all harmonic peaks may be assigned a local envelope (e.g., very low harmonic peaks).

FIG. 28 is a graph illustrating an example of assignment of local envelopes for individual harmonic peaks. The graph in FIG. 28 is illustrated in amplitude (dB) 2876 over a frequency spectrum (Hz) 2804. The local envelopes (e.g., formant peak models) illustrated in FIG. 28 correspond to the peaks described in connection with FIG. 26. For example, the second, fourth and twenty-first harmonic peaks illustrated in FIG. 26 and the corresponding assigned local envelopes are shown in FIG. 28.

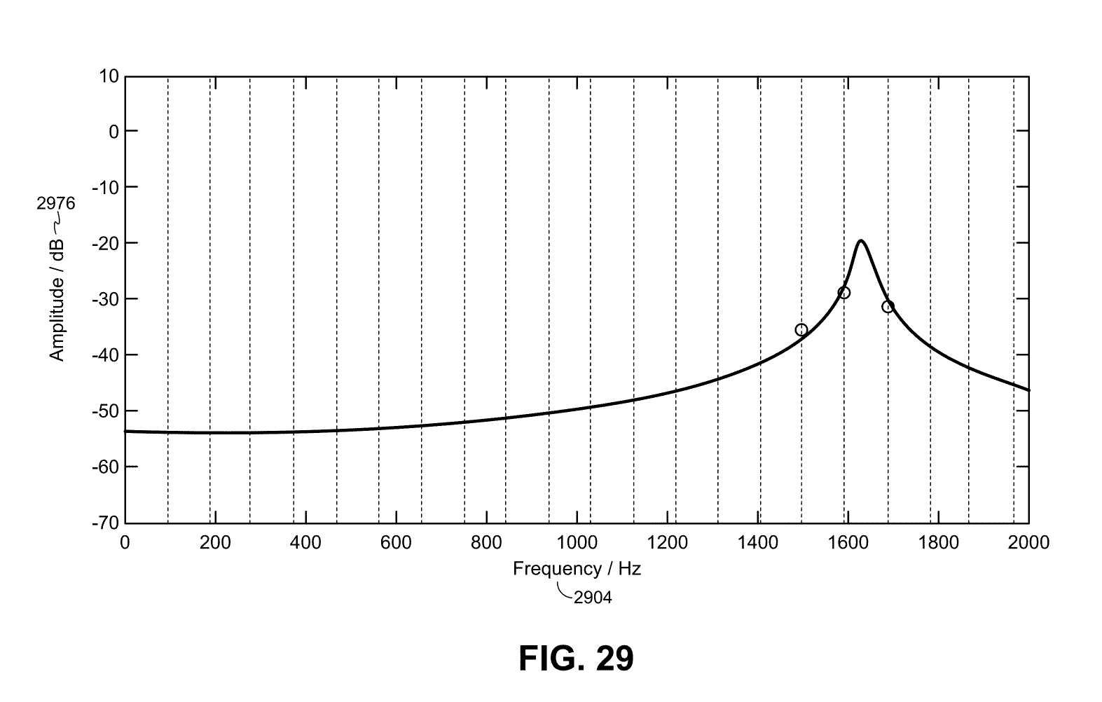

In the case of formant groups (e.g., supported peaks), the electronic device 1614 may also assign a single local envelope to a formant group. For example, the electronic device 1614 may assign a single local envelope to the group of consecutive harmonic peaks formed by the sixteenth, seventeenth and eighteenth peaks from FIG. 26 as described in connection with FIG. 29. A single local envelope can be assigned to match all the three harmonic peaks, instead of assigning three local envelopes matching the harmonic peaks individually. To assign the single local envelope, for example, the electronic device 1614 may also use an all-pole filter's frequency response. Specifically, this all-pole filter may still have 2 poles, conjugate to each other. In this case, however, the pole's angle and strength, as well as the filter's gain may be set (by the electronic device 1614) in such a way that this filter's frequency response matches all the three harmonic peaks. For example, the electronic device 1614 may solve a set of equations governing the frequency response at the three harmonic frequencies. This can also be achieved by a technique called discrete all-pole modeling.

FIG. 29 is a graph illustrating an example of assignment of a single local envelope for a group of harmonic peaks or a formant group. The graph in FIG. 29 is illustrated in amplitude (dB) 2976 over a frequency spectrum (Hz) 2904. In this example, the formant group composed of the sixteenth, seventeenth and eighteenth peaks from FIG. 26 is assigned a single 2-pole filter's response as the local envelope.

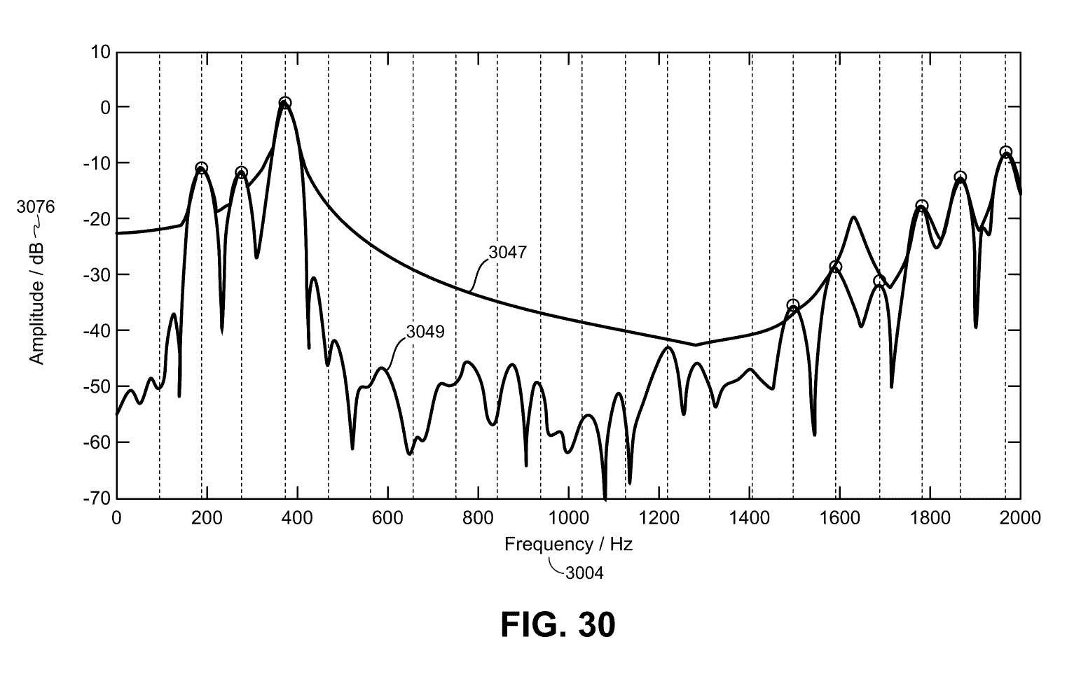

The electronic device 1614 may merge local envelopes to produce a global envelope. Local envelopes may be based on individual harmonic peaks, based on formant groups or based on a combination of the two cases. In some configurations, the electronic device 1614 may form a global envelope without disrupting local matching (e.g., the local envelope modeling described above). For example, the electronic device 1614 may use the max operation (e.g., at each frequency bin, the global envelope is the max value of all the local envelopes at the same frequency bin). FIG. 30 provides one example of the max value of all the local envelopes (including those depicted in FIGS. 28-29, for example). It should be noted that the electronic device 1614 may utilize other approaches to merge the local envelopes. For example, the electronic device 1614 may obtain a Euclidean norm of the local envelopes at each frequency bin (e.g., a max operation corresponding to the infinite norm).

FIG. 30 is a graph illustrating an example of a global envelope. The graph in FIG. 30 is illustrated in amplitude (dB) 3076 over a frequency spectrum (Hz) 3004. In particular, FIG. 30 illustrates the global envelope 3047 over the speech spectrum 3049. From 400 Hz to 1400 Hz, the global envelope is significantly higher than the speech spectrum (up to approximately 30 dB, for example).

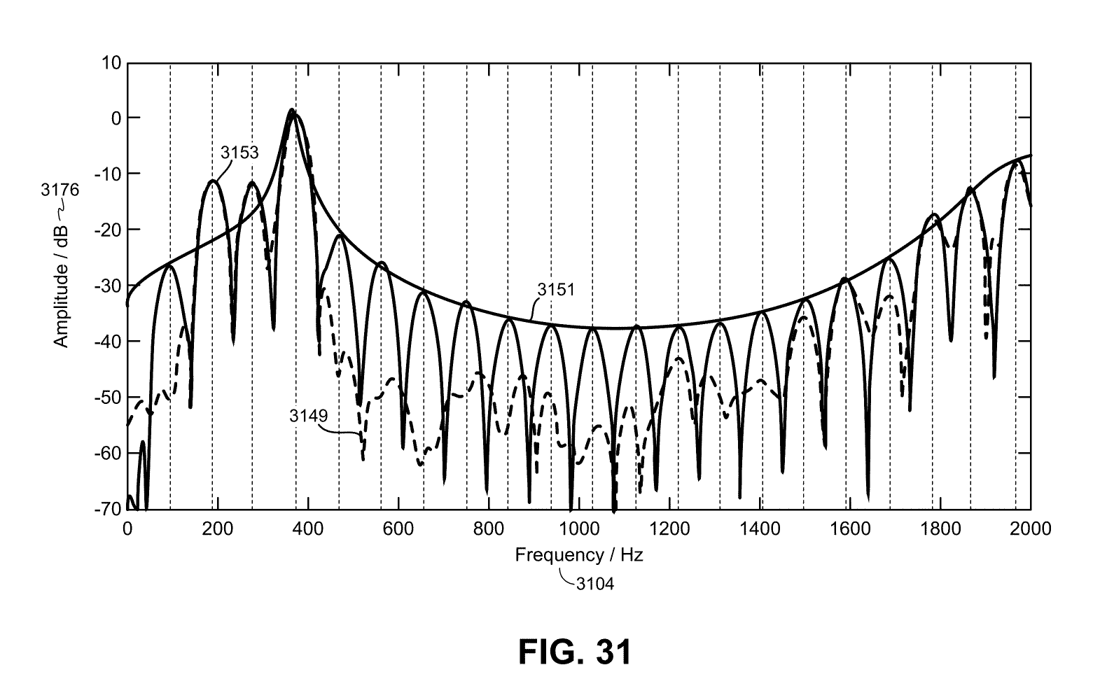

The electronic device 1614 may optionally perform post-processing of the merged global envelope. The merged envelope may be continuous but not necessarily smooth, as illustrated in FIG. 30. In some configurations, the electronic device 1614 may apply some post-processing (e.g., a moving average of the merged global envelope, as shown in FIG. 31) for a smoother envelope. In some configurations (for a minimum phase corresponding to the speech envelope, for example), the electronic device 1614 may apply discrete all-pole modeling to derive an all-pole filter from the merged global envelope. In these configurations, the minimum phase may be the all-pole filter frequency response's angle.

FIG. 31 is a graph illustrating an example of missing partial restoration. The graph in FIG. 31 is illustrated in amplitude (dB) 3176 over a frequency spectrum (Hz) 3104. In particular, FIG. 31 illustrates a speech spectrum 3149, a smoothed global envelope 3151 and restored speech spectrum 3153. The dashed vertical lines denote harmonic frequencies.

One application of the global envelope is to restore a missing component of the speech spectrum. Given fundamental frequencies and the global envelope, the electronic device 1614 may restore the spectrum by placing harmonic peaks with amplitudes determined by the global envelope when they are missing. For example, the fifth to fifteenth harmonic peaks (from approximately 400 Hz to 1400 Hz) may be restored as illustrated in FIG. 31. If a harmonic peak exists but is lower than the global envelope, the electronic device 1614 may increase the harmonic peak's amplitude to the envelope (as illustrated by the sixteenth and eighteenth harmonic peaks in FIG. 31, for example). If a harmonic peak exists but is higher than the global envelope, the electronic device 1614 may maintain its amplitude (as illustrated by the second and third harmonic peaks in FIG. 31, for example).

In some configurations of the systems and methods disclosed herein, an electronic device 1614 may generate a first model for a first local peak. The first local peak may have at least one missing neighboring peak located at neighboring harmonic positions of the first local peak. For example, the first local peak may be an unsupported local peak and the electronic device 1614 may generate the first model based on fixed 2-pole modeling. The electronic device 1614 may generate a second model for a second local peak based on neighboring peaks located at neighboring harmonic positions of the second local peak. For example, the second local peak may be a supported local peak and the electronic device 1614 may generate the second model based on adaptive 2-pole modeling. The electronic device 1614 may generate a merged envelope based on a combination of the first model and the second model. For example, the electronic device 1614 may perform a maximum operation with the models. For instance, the maximum operation may take the maximum (e.g., highest amplitude) value between the models for each frequency bin to produce a maximum envelope.

FIG. 32 is a block diagram illustrating another configuration of an electronic device 3214 in which systems and methods for enhancing an audio signal 3216 may be implemented. The electronic device 3214 may include a minimum phase estimation module 3255 and/or a phase synthesis module 3226. The phase synthesis module 3226 described in connection with FIG. 32 may be one example of the phase synthesis module 326 described in connection with FIG. 3. The electronic device 3214 may determine one or more (first) phases based on the current frame (e.g., based only on information corresponding to the current frame). The electronic device 3214 may also determine one or more (second) phases based on the current frame and a previous frame (e.g., based on information corresponding to the current frame and to the previous frame). The electronic device 3214 may determine (e.g., synthesize) one or more (third) phases based on the one or more first phases and based on the one or more second phases. In some configurations of the systems and methods disclosed herein, an electronic device 3214 may estimate phase information as follows.

The minimum phase estimation module 3255 may estimate a minimum phase (e.g., a plurality of minimum phases for the current frame) based on an audio signal 3216. For example, minimum phase may be an all-pole filter frequency response's angle as described above. In some configurations, the minimum phase estimation module 3255 may estimate (or search for) a plurality of minimum phases (e.g., φₖ^{m}) for a current frame. For example, the electronic device 3214 may obtain one minimum phase for each of the restored speech peaks.

The group delay estimation module 3257 may estimate a group delay for a current frame based on the plurality of minimum phases. The first phase generation module 3259 may generate a plurality of first phases based on the group delay and the plurality of minimum phases.

The first phase generation module 3259 may generate (or calculate) a plurality of first phases (e.g., φₖ^{f}) based on the group delay and the plurality of minimum phases. For example, the first phase generation module 3259 may generate the plurality of first phases in accordance with the equation φₖ^{f}=−fₖd+φₖ^{m}.

The second phase generation module 3261 may generate (or calculate) a plurality of second phases (e.g., “maximal consistency phases” φ^{c}) based on a comparison between a first portion of the current frame and a second portion of a previous frame. The previous frame may immediately precede the current frame. For example, the second phase generation module 3261 may determine a phase that maximizes continuity or “consistency” in phase between the current frame and the previous frame. It should be noted that the electronic device 3214 (e.g., second phase generation module 3261) may utilize other approaches for determining a phase based on the current frame and a previous frame.

The electronic device 3214 (e.g., phase adjustment module 3263) may adjust the plurality of first phases (e.g., φₖ^{f}) based on the plurality of second phases (e.g., φ^{c}). This may result in phases 3265.

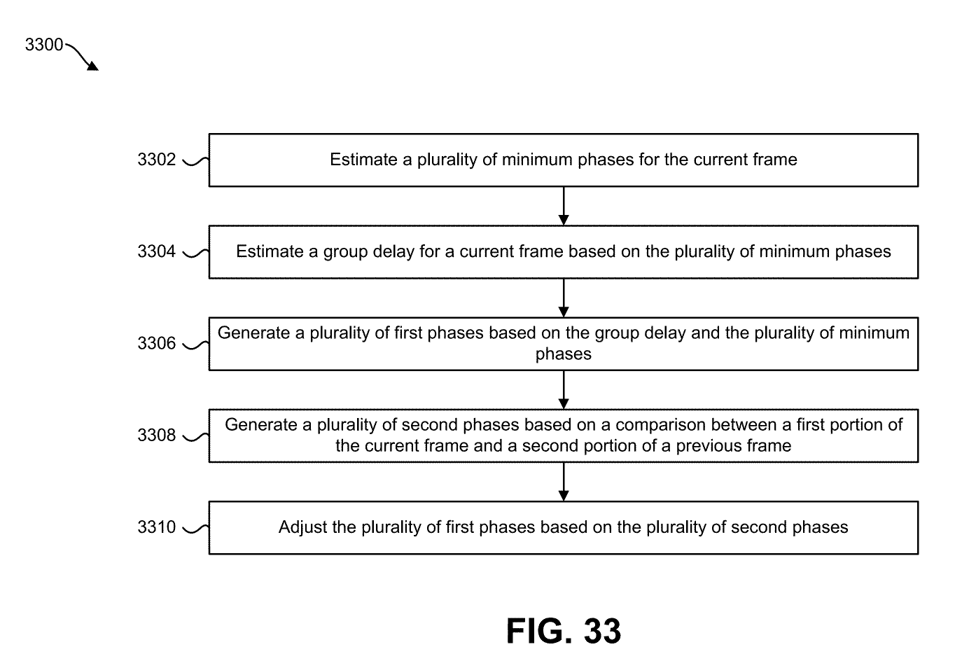

FIG. 33 is flow diagram illustrating one configuration of a method for synthesizing phase. The electronic device 3214 may estimate 3302 a plurality of minimum phases for the current frame. This may be accomplished as described above in connection with FIG. 32. The electronic device 3214 may estimate 3304 a group delay for a current frame based on the plurality of minimum phases. This may be accomplished as described above in connection with FIG. 32.

The electronic device 3214 may generate 3306 a plurality of first phases based on the group delay and the plurality of minimum phases. This may be accomplished as described above in connection with FIG. 32. The electronic device 3214 may generate 3308 a plurality of second phases based on comparison between a first portion of the current frame and a second portion of a previous frame. This may be accomplished as described above in connection with FIG. 32.

The electronic device 3214 may adjust 3310 the plurality of first phases based on the plurality of second phases. This may be accomplished as described above in connection with FIG. 32.

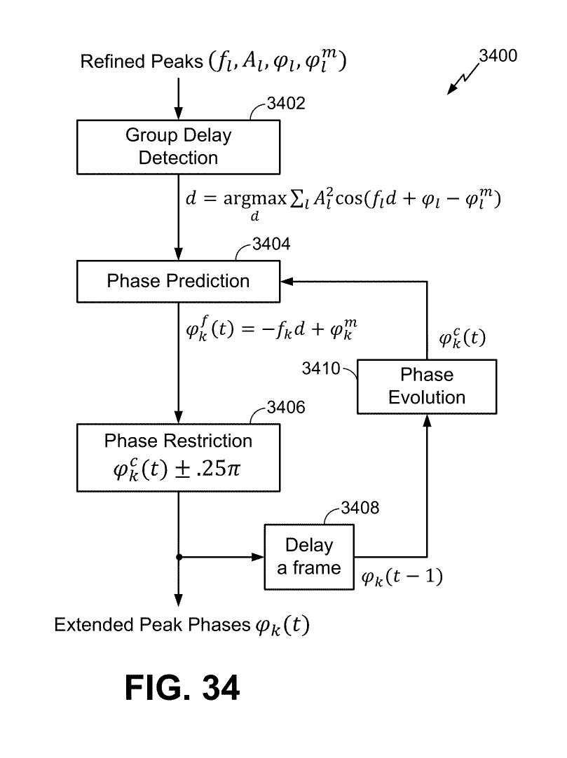

FIG. 34 is a flow diagram illustrating a more specific example of an approach for phase (re) synthesis by inter-partial and inter-frame constraints. This may be performed for missing partials. Group delay (e.g., d) may be one example of an inter-partial constraint. The electronic device 3214 may perform 3402 group delay detection. This may be based on refined peaks. For example, the electronic device 3214 may search for the linear phase component across refined peaks after removing the minimum phase. In some configurations, this may be performed in accordance with

$$d = arg {min}_{d} {\sum }_{l} {‖ {A}_{l} {e}^{j ( {ϕ}_{l} - {ϕ}_{l}^{m} )} - {A}_{l} {e}^{- j {f}_{l} d} ‖}^{2} = {arg max}_{d} {\sum }_{l} {A}_{l}^{2} cos ( {f}_{l} d + {ϕ}_{l} - {ϕ}_{l}^{m} ) ,$$

where subscript l is over all existing harmonic peaks (e.g., partials) in a frame and where Aₗ, φₗ, φₗ^{m} and fₗ are the amplitude, phase, minimum phase and frequency of the lth harmonic peaks, respectively (and where all of these variables are for the same frame t, for example).

The electronic device 3214 may perform 3404 phase prediction within a frame. For example, this may be performed for extended harmonic peaks (e.g., missing harmonic peaks) based on existing harmonic peaks. The predicted phase for the kth harmonic peak, φₖ^{f}, called inter-partial phases hereafter, may be determined in accordance with φₖ^{f}=−fₖd+φₖ^{m}, where fₖ and φₖ^{m} are frequency and phase of the kth harmonic peak.

One example of an inter-frame constraint is phase evolution. The electronic device 3214 may calculate 3410 phase evolution to obtain a maximal consistency phase φₖ^{c}(t). This may help to address consistency on an overlapped region. As used herein, N_{w} is a window length and w(n) for n=0, 1, . . . , N_{w}−1 is a window function. Additionally, M is a hop size (e.g., a shift in samples between neighboring windows), x₀ is a reconstructed time signal for the last window span and x₁ is a reconstructed time signal for the current window span. Over the overlapped region for n=0, 1, . . . , N_{w}−M−1, the time signal from x₀ is x₀(n+M) and the time signal from x₁ is x₁(n). The temporal consistency between x₀ and x₁, denoted as C(x₀, x₁) may be defined as C(x₀,x₁)=Σₙv(n)x₀(n+M)x₁ (n), where v(n) for n=0, 1, . . . , N_{w}−M−1 is a weighting function defined as v(n)=w²(n+M)w²(n)/w²(n+M)+w²(n)). Maximal consistency phase may be denoted as φ^{c}. The maximal consistency phase for frame t, φₖ^{c}(t), may be the phase that maximizes consistency on an overlapped region α=(N_{w}−1)/(2M). In particular, the maximal consistency phase φₖ^{c}(t) may be calculated in accordance with φₖ^{c}(t)=φₖ(t−1)+0.5(fₖ(t)+fₖ(t−1))M−α(fₖ(t)−fₖ(t−1))M, in which φₖ(t−1) is the synthesized phase of the kth harmonic peak in frame t−1.

The electronic device 3214 may use the inter-partial phase in frame t, φₖ^{f}(t) and the maximal consistency phase in φₖ^{c}(t) to synthesize the phase for the kth harmonic peak in frame t. This may be performed by restricting φₖ^{f}(t) to some continuous range of phase covering φₖ^{c}(t) (e.g., the interval of [φₖ^{c}(t)−0.25π, φₖ^{c}(t)+0.25π] to maintain inter-frame phase consistency. As illustrated in FIG. 34, the electronic device 3214 may perform 3406 phase restriction. For example, the electronic device 3214 may set φₖ(t)=φₖ^{c}(t)+0.25π if φₖ^{f}(t)>φₖ^{c}(t)+0.25π, φₖ(t)=φₖ^{c}(t)−0.25π if φₖ^{f}(t)<φₖ^{c}(t)−0.25π and φₖ(t)=φₖ^{f}(t) otherwise. Restricting 3406 the phase may result in extended peak phases φₖ(t). The electronic device 3214 may delay 3408 a frame of the extended peak phases, resulting in φₖ(t−1), which may be used to calculate the maximal consistency phase φₖ^{c}(t).

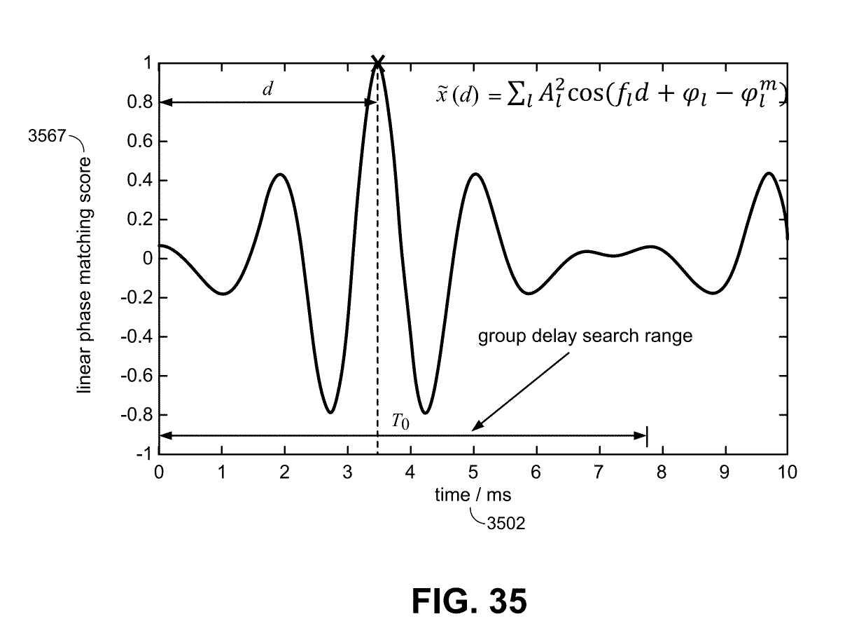

FIG. 35 includes a graph illustrating an example of searching for a linear phase component as described in connection with FIG. 34. The graph is illustrated as the linear phase matching score 3567 over time (ms) 3502. In particular, FIG. 35 illustrates an example of a group delay search range and the group delay d.

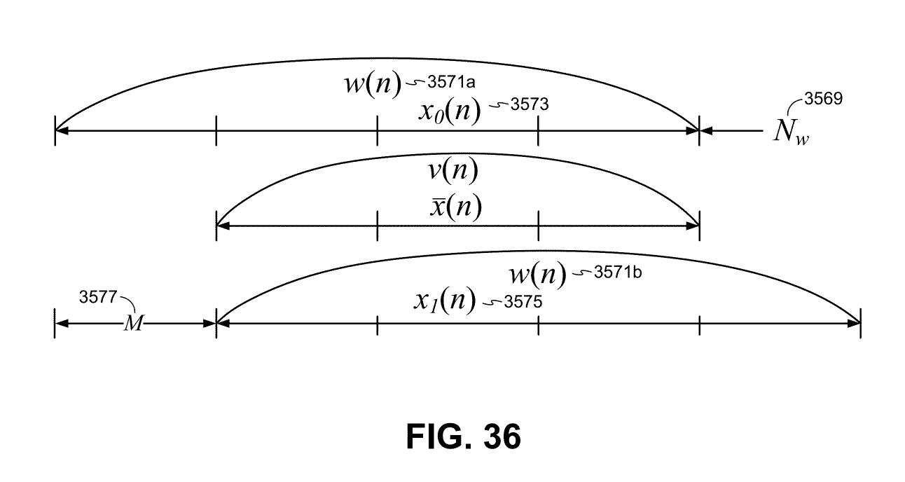

FIG. 36 is a diagram illustrating an example of phase evolution as described in connection with FIG. 34. In particular, FIG. 36 illustrates a window length N_{w} 3569, a window function w(n) 3571a over a reconstructed time signal for the last window span x₀ 3573, the window function 3571b over a reconstructed time signal for the current window span x₁ 3575, a hop size M 3577, and the overlapped segment of the signal x̅(n) with a weighting function v(n). As described above, phase evolution may be one example of the inter-frame constraint used in phase synthesis (e.g., resynthesis) in accordance with the systems and methods disclosed herein.

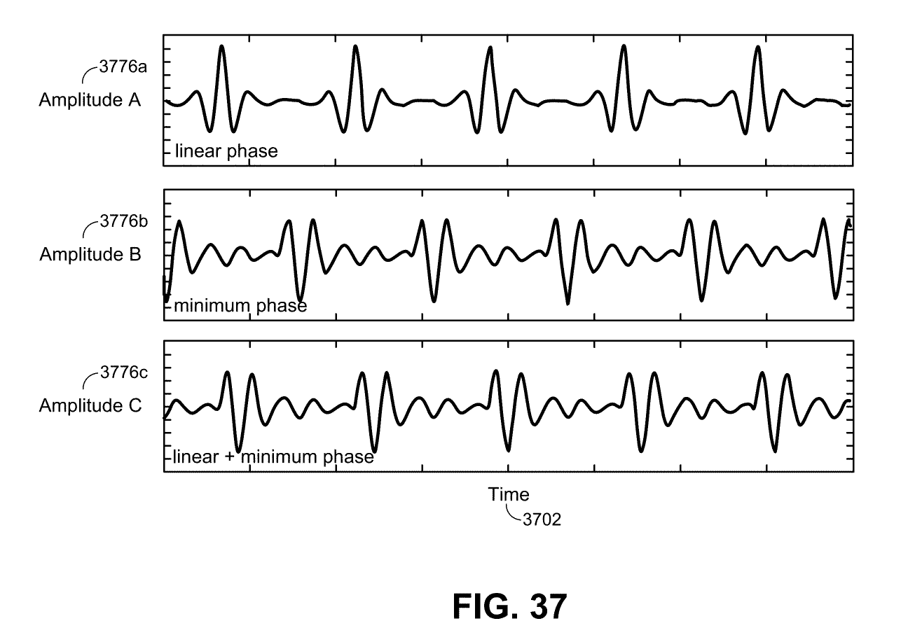

FIG. 37 includes graphs illustrating another example of phase evolution as described in connection with FIG. 34. The graphs in FIG. 37 are illustrated in amplitudes 3776a-c over time 3702. In particular, FIG. 37 illustrates a linear phase, a minimum phase and a combination of linear phase and minimum phase.

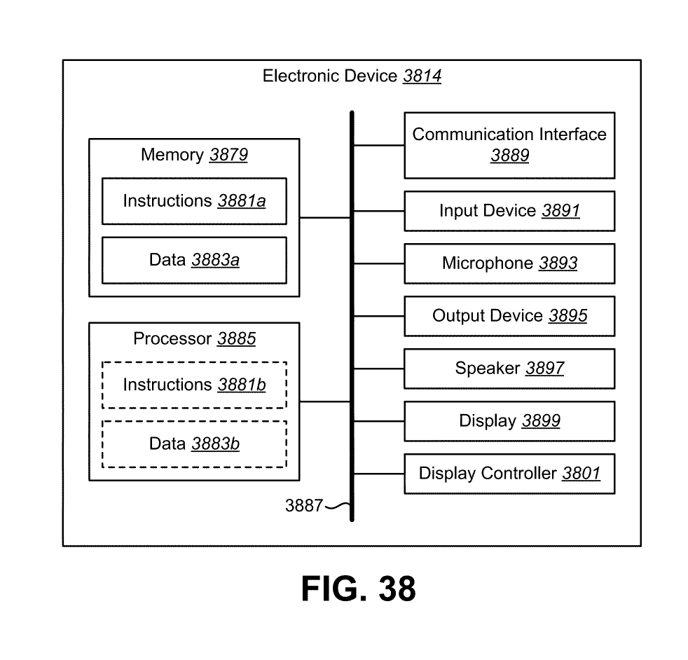

FIG. 38 illustrates various components that may be utilized in an electronic device 3814. The illustrated components may be located within the same physical structure or in separate housings or structures. The electronic device 3814 described in connection with FIG. 38 may be implemented in accordance with one or more of the electronic devices 314, 1614, 3214 described herein. The electronic device 3814 includes a processor 3885. The processor 3885 may be a general purpose single- or multi-chip microprocessor (e.g., an ARM), a special purpose microprocessor (e.g., a digital signal processor (DSP)), a microcontroller, a programmable gate array, etc. The processor 3885 may be referred to as a central processing unit (CPU). Although just a single processor 3885 is shown in the electronic device 3814 of FIG. 38, in an alternative configuration, a combination of processors (e.g., an ARM and DSP) could be used.

The electronic device 3814 also includes memory 3879 in electronic communication with the processor 3885. That is, the processor 3885 can read information from and/or write information to the memory 3879. The memory 3879 may be any electronic component capable of storing electronic information. The memory 3879 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 3883a and instructions 3881a may be stored in the memory 3879. The instructions 3881a may include one or more programs, routines, sub-routines, functions, procedures, etc. The instructions 3881a may include a single computer-readable statement or many computer-readable statements. The instructions 3881a may be executable by the processor 3885 to implement one or more of the methods, functions and procedures described above. Executing the instructions 3881a may involve the use of the data 3883a that is stored in the memory 3879. FIG. 38 shows some instructions 3881b and data 3883b being loaded into the processor 3885 (which may come from instructions 3881a and data 3883a).

The electronic device 3814 may also include one or more communication interfaces 3889 for communicating with other electronic devices. The communication interfaces 3889 may be based on wired communication technology, wireless communication technology, or both. Examples of different types of communication interfaces 3889 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The electronic device 3814 may also include one or more input devices 3891 and one or more output devices 3895. Examples of different kinds of input devices 3891 include a keyboard, mouse, microphone, remote control device, button, joystick, trackball, touchpad, lightpen, etc. For instance, the electronic device 3814 may include one or more microphones 3893 for capturing acoustic signals. In one configuration, a microphone 3893 may be a transducer that converts acoustic signals (e.g., voice, speech) into electrical or electronic signals. Examples of different kinds of output devices 3895 include a speaker, printer, etc. For instance, the electronic device 3814 may include one or more speakers 3897. In one configuration, a speaker 3897 may be a transducer that converts electrical or electronic signals into acoustic signals. One specific type of output device which may be typically included in an electronic device 3814 is a display device 3899. Display devices 3899 used with configurations disclosed herein may utilize any suitable image projection technology, such as a cathode ray tube (CRT), liquid crystal display (LCD), light-emitting diode (LED), gas plasma, electroluminescence, or the like. A display controller 3801 may also be provided, for converting data stored in the memory 3879 into text, graphics, and/or moving images (as appropriate) shown on the display device 3899.

The various components of the electronic device 3814 may be coupled together by one or more buses, which may include a power bus, a control signal bus, a status signal bus, a data bus, etc. For simplicity, the various buses are illustrated in FIG. 38 as a bus system 3887. It should be noted that FIG. 38 illustrates only one possible configuration of an electronic device 3814. Various other architectures and components may be utilized.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for enhancing an audio signal by an electronic device, comprising:
determining formant peaks based on an audio signal;
generating formant peak models, wherein generating formant peak models comprises individually modeling each formant peak; and
generating a global envelope based on the formant peak models.

2. The method of claim 1, wherein individually modeling each formant peak comprises:
determining whether each formant peak is supported; and
selecting a modeling type for each formant peak based on whether each respective formant peak is supported.

3. The method of claim 1, wherein individually modeling each formant peak comprises, for each formant peak, modeling the formant peak based on a first modeling if the formant peak has at least one missing neighboring peak at a harmonic position of the formant peak or modeling the formant peak based on a second modeling if the formant peak has neighboring peaks at neighboring harmonic positions of the formant peak.

4. The method of claim 1, further comprising synthesizing phase based on the global envelope.

5. The method of claim 4, wherein synthesizing the phase is based on an inter-partial constraint and an inter-frame constraint.

6. The method of claim 1, further comprising performing harmonic analysis based on the audio signal.

7. The method of claim 6, wherein performing harmonic analysis comprises:
pruning a set of spectral peaks to obtain a pruned set of spectral peaks;
determining a fundamental frequency by determining a generalized common divisor of the pruned set of spectral peaks; and
updating a voicing state based on the fundamental frequency.

8. The method claim 6, further comprising determining whether the audio signal includes one or more voiced frames based on the harmonic analysis, wherein determining formant peaks is only performed for voiced frames.

9. The method of claim 1, further comprising generating a time-domain speech signal based on the global envelope.

10. The method of claim 1, further comprising transmitting one or more of the formant peak models.

11. The method of claim 1, further comprising suppressing one or more isolated peaks based on the audio signal, wherein suppressing the one or more isolated peaks comprises:
determining at least two peak isolation measures; and
updating an isolated peak state based on the at least two peak isolation measures.

12. The method of claim 1, wherein generating the global envelope based on the formant peak models comprises one or more of performing a max operation on the formant peak models and concatenating the formant peak models.

13. An electronic device for enhancing an audio signal, comprising:
formant peak determination circuitry configured to determine formant peaks based on an audio signal; and
global envelope generation circuitry coupled to the formant peak determination circuitry, wherein the global envelope generation circuitry is configured to generate formant peak models and is configured to generate a global envelope based on the formant peak models, wherein generating formant peak models comprises individually modeling each formant peak.

14. The electronic device of claim 13, wherein individually modeling each formant peak comprises:
determining whether each formant peak is supported; and
selecting a modeling type for each formant peak based on whether each respective formant peak is supported.

15. The electronic device of claim 13, wherein individually modeling each formant peak comprises, for each formant peak, modeling the formant peak based on a first modeling if the formant peak has at least one missing neighboring peak at a harmonic position of the formant peak or modeling the formant peak based on a second modeling if the formant peak has neighboring peaks at neighboring harmonic positions of the formant peak.

16. The electronic device of claim 13, further comprising phase synthesis circuitry coupled to the global envelope generation circuitry, wherein the phase synthesis circuitry is configured to synthesize phase based on the global envelope.

17. The electronic device of claim 16, wherein synthesizing the phase is based on an inter-partial constraint and an inter-frame constraint.

18. The electronic device of claim 13, further comprising harmonic analysis circuitry coupled to the global envelope generation circuitry, wherein the harmonic analysis circuitry is configured to perform harmonic analysis based on the audio signal.

19. The electronic device of claim 18, wherein performing harmonic analysis comprises:
pruning a set of spectral peaks to obtain a pruned set of spectral peaks;
determining a fundamental frequency by determining a generalized common divisor of the pruned set of spectral peaks; and
updating a voicing state based on the fundamental frequency.

20. The electronic device claim 18, wherein the harmonic analysis circuitry is further configured to determine whether the audio signal includes one or more voiced frames based on the harmonic analysis, wherein determining formant peaks is only performed for voiced frames.

21. The electronic device of claim 13, further comprising time-domain synthesis circuitry coupled to the global envelope generation circuitry, wherein the time-domain synthesis circuitry is configured to generate a time-domain speech signal based on the global envelope.

22. The electronic device of claim 13, further comprising a transmitter coupled to the global envelope generation circuitry, wherein the transmitter is configured to transmit one or more of the formant peak models.

23. The electronic device of claim 13, further comprising isolated peak suppression circuitry coupled to the global envelope generation circuitry, wherein the isolated peak suppression circuitry is configured to suppress one or more isolated peaks based on the audio signal, wherein suppressing the one or more isolated peaks comprises:
determining at least two peak isolation measures; and
updating an isolated peak state based on the at least two peak isolation measures.

24. The electronic device of claim 13, wherein generating the global envelope based on the formant peak models comprises one or more of performing a max operation on the formant peak models and concatenating the formant peak models.

25. A computer-program product for enhancing an audio signal, comprising a non-transitory tangible computer-readable medium having instructions thereon, the instructions comprising:
code for causing an electronic device to determine formant peaks based on an audio signal;
code for causing the electronic device to generate formant peak models, wherein generating formant peak models comprises individually modeling each formant peak; and
code for causing the electronic device to generate a global envelope based on the formant peak models.

26. The computer-program product of claim 25, wherein individually modeling each formant peak comprises:
determining whether each formant peak is supported; and
selecting a modeling type for each formant peak based on whether each respective formant peak is supported.

27. The computer-program product of claim 25, wherein individually modeling each formant peak comprises, for each formant peak, modeling the formant peak based on a first modeling if the formant peak has at least one missing neighboring peak at a harmonic position of the formant peak or modeling the formant peak based on a second modeling if the formant peak has neighboring peaks at neighboring harmonic positions of the formant peak.

28. An apparatus for enhancing an audio signal, comprising:
means for determining formant peaks based on an audio signal;
means for generating formant peak models, wherein the means for generating formant peak models comprises means for individually modeling each formant peak; and
means for generating a global envelope based on the formant peak models.

29. The apparatus of claim 28, wherein the means for individually modeling each formant peak comprises:
means for determining whether each formant peak is supported; and
means for selecting a modeling type for each formant peak based on whether each respective formant peak is supported.

30. The apparatus of claim 28, wherein the means for individually modeling each formant peak comprises, for each formant peak, means for modeling the formant peak based on a first modeling if the formant peak has at least one missing neighboring peak at a harmonic position of the formant peak or means for modeling the formant peak based on a second modeling if the formant peak has neighboring peaks at neighboring harmonic positions of the formant peak.
